(19) United States
(12) Patent Application Publication
(10) Pub. No.: US 2023/0041700 A1
(43) Pub. Date: Feb. 9, 2023

(54) LiDAR TOOL FOR OIL AND GAS WELLBORE DATA ACQUISITION

(71) Applicant: Defiant Engineering, LLC, Houston, TX (US)

(72) Inventors: Stanley Jonathan Blois, Alberta (CA); Emma Abigael Jones, Tomball, TX (US); Gareth Nicholas Jones, Tomball, TX (US); Cullen Keyes, Hysham, MT (US); Ian Graham Janke, Alberta (CA); Lawrence Gene Griffin, Morrison, CO (US)

(21) Appl. No.: 17/815,130

(22) Filed: Jul. 26, 2022

Related U.S. Application Data
(60) Provisional application No. 63/229,441, filed on Aug. 4, 2021.

(51) Int. Cl. G01S 17/894; G01S 7/481; G01S 7/4865; G01S 7/4861; G01S 7/487

(52) U.S. Cl. CPC G01S 17/894; G01S 7/4813; G01S 7/4865; G01S 7/4861; G01S 7/487

(57) ABSTRACT

In one example, an apparatus includes a TLT (Time of Flight (TOF)/LiDAR tool) with one or more optical transmitters and optical receivers that are operable to cooperate to obtain data concerning a downhole feature when the apparatus is deployed in a downhole environment. This apparatus further includes a first device operable to determine a position, speed, and/or orientation, of the TLT, when the TLT is deployed in the downhole environment, a second device configured to store locally and/or transmit the data to a location on a surface, a power source connected to the TLT, the first device, and the second device, and a housing within which the TLT, first device, second device, and power source are disposed, and the housing includes a connector configured to interface with a piece of downhole equipment.

### BACKGROUND

After a conventional oil and gas well is drilled, cased, and cemented, more work is required and performed in order to get the well into production. The next step after drilling is completing the well. The first step to completing the well is to hydraulically fracture, in multiple stages/zones, the lateral portion of the wellbore. Hydraulic fracturing, or simply ‘fracturing’ or ‘fracking,’ of the well may involve multiple companies, a large amount of equipment, and personnel on site to perform the fracturing or ‘frac.’

For example, companies on site may include an oil company representative, a wireline company, a frac company, water haulers and services, a crane company, and downhole tool company. Each of these companies may have its own respective personnel on site as well. Equipment on site may include one or more cranes, one or more wireline vehicles, several high pressure pump vehicles, sand hoppers for hauling and dumping sand, one or more blending units for blending sand, chemicals, and any other additives needed, a central manifold/missile, one or more data vans, one or more chemical units, and water storage tanks.

Once all of the equipment to perform the frac is on site and rigged up to the well, they will begin the frac process. The process begins by installing a plug and perforation gun tool to the wireline. The plug and perforation tool is placed into the well using wireline and then pumped down the well with fluid forcing it to the desired location within the lateral portion of the wellbore. Once to the desired location, wireline then sets the plug, detaches from it and pulls up the wellbore to the next desired location. Once at the next desired location, wireline then sets off the perforation gun tool, normally jet charges, and perforates small holes into the side of the wellbore through the casing and cement into the formation. Once this is completed, wireline will then pull the tool out of the wellbore and the crane will help them set the tool down on the surface.

Now that the plug has created a barrier and perforations have been made for water, sand, and chemical to enter, the frac company will then begin pumping frac fluids down the wellbore. Once the frac fluid mix build up enough pressure in the wellbore, against the plug, the frac fluid mix will then fracture the formation where the perforations were made. Once a positive fracture has been performed, the frac company will then slow to a stop on pumping. If necessary, some mixed fluids are then flowed back up the well and out of the wellbore. This is the completion of stage/zone one of the hydraulic frac.

Once the perforation gun and plug are reset and ready for the next stage/zone, the process will then be repeated to complete stage/zone two of the hydraulic frac using the same process as previously described. The perf gun and plug will be pumped down the wellbore until they touch the previously set plug, and then pulled back up the wellbore to the next desired location, where plug two will be set and perforation of stage/zone two will be performed. The wireline and perf gun may then be retrieved completely out of the wellbore. The hydraulic fracturing process of pumping mixed frac fluids for stage/zone two will then begin once the wireline is out of the wellbore. The running of the wireline, setting plugs and perforating, and fracturing the wellbore with mixed frac fluids is repeated 10 to 60, or more, times per every unconventional wellbore. Thus, creating multiple stages/zones per wellbore leaving multiple, 10 to 60 or more plugs left in the wellbore between and isolating each stage/zone. The plugs can vary in their composition, and may be made of polymers, ceramics, and metals. The wellbore cannot produce any product of oil, gas, water, etc. until the plugs are removed or remediated according to the design of the plug chosen to be used. Once the frac process of fracturing multiple zones, or to the oil companies desired needs for the well, the frac equipment and all other equipment on site is rigged down and moved off the well site. It is noted that some oil companies may perform a “zipper frac,” which refers to the idea that the frac company, and other necessary companies, will rig up to two wells on the multiple well site and work simultaneously on each well performing plug, perforate, and frac. One well frac process can take up to seven or more days to perform. Zipper fracs take up to seven or more days to perform two wells at a time.

Now that the frac has been completed successfully and all equipment and personnel have left the site, it is now time to remove/drill out, or remediate the existing plugs in the wellbore. This process is performed with either, or a few different types of equipment.

One of these operations is performed with coiled tubing, a downhole drilling motor, or bit, pumping unit(s), nitrogen unit(s) if needed, water tank(s), crane(s), and coiled tubing personnel. Other personnel will include the oil company's representative(s) and the downhole tool company's representative(s). This process is performed by continuous, one size and one piece, of tubing running in the wellbore with a motor, or bit, attached to the end of the tubing. The motor, or bit, is rotated for drilling by pumping fluids through the coiled tubing. Once the coiled tubing reaches the first plug, it will then begin pumping to rotate the motor, or bit, and drill out the plug. Coiled tubing will continue throughout the wellbore until it has reached its strength limit or has drilled out every plug left in the well bore. If coiled tubing has drilled out every existing plug, pumping commences to wash out any remaining debris potentially left in the wellbore. Once completed with the drill out process, coiled tubing will then pull out of the wellbore and rig down. This process can take between 24 and 40 hours to completely perform on 24 hour operations. The well is now ready to produce oil, gas, water, etc.

The other process is done with a Hydraulic Workover Rig and stick drill pipe, or tubing. Stick drill pipe, or tubing, is roughly thirty feet in length and each stick is connected with tongs and a collar for each stick, or joint of pipe. Equipment on location will include the rig and water tank(s). Personnel on location will include the Workover Rig personnel, oil company representative(s), and the downhole tool company's representative(s). This process is executed by rigging the workover rig up to the well head, implementing its Blow Out Preventer on the well head, and then entering the wellbore. The wellbore is entered with the downhole motor, or bit, connected to the first joint of pipe. The workover rig will run in many joints of pipe, having to stop to pick up more pipe and connect the pipe, before completing the drill out of plugs process. Once the drill pipe has reached the first plug, water is then pumped down the wellbore to actuate the motor, or bit, and begin drilling out the plug until it is gone. This is done with either a downhole motor, which requires water to rotate the bit, or by a rotary drive, top or bottom drive, which physically rotates the pipe. Either process is performed until all the plugs have been drilled out. Once they have completed the drill out process, the workover rig will pull out of the wellbore, having to stop to disconnect every joint of pipe, and lay every joint of pipe down on the surface until they have come completely out of the wellbore. This process can take up to 72 hours to completely perform on 24 hour operations. They will then rig down and leave the well site, or move over to the next adjacent well.

Another process for completing the drill out of plugs process is done by a hydraulic snubbing unit, either stand alone or rig assisted. Stand Alone snubbing units can perform the drill out of plugs process on its own. The Rig Assisted snubbing unit completes this process with the assistance of the Hydraulic Workover Rig, as described in the previous description of existing processes. The Stand Alone snubbing unit process will consists of the snubbing unit, water tank(s), and pump(s) on location.

Personnel will include the snubbing unit personnel, oil company representative(s), and the downhole tool company representative(s). The snubbing unit uses hydraulic jack cylinders to snub/force the pipe and motor, or bit, into the wellbore. The stroke lengths of these cylinders is up to, or slightly more than, twelve feet. This process is limited due to the length of the stroke, making this a lengthy process. The snubbing unit snubs the stick pipe, stops to pick up pipe and make connection, and runs the pipe into the wellbore until it reaches the first plug.

Once it reaches the first plug, the snubbing unit will either use a rotary table to physically rotate the pipe and drill out the plug, or pump water to actuate the motor, or bit, and rotate it to drill out the plug. Once the plug has been drilled out, the snubbing unit will continue to run into the wellbore until it drills out all of the existing plugs. Once the plugs are all drilled out, the snubbing unit will then begin snubbing the pipe out of the wellbore, disconnecting the joints of pipe, laying the pipe down on the surface, until it has completely come out of the wellbore. The snubbing unit will then rig down, move off site, or to the adjacent well. This process takes up to 96 hours or more to completely perform on 24 hour operations. The Rig Assisted snubbing unit performs the same operation as the standalone unit, only with the assistance of the work over rig.

Another process is executed with a fiber optic cable unit, and an attached drilling device that is electrically powered. The equipment on site for this operation is the fiber optic cable unit, pump(s), and water tank(s). The personnel on location are all cable unit personnel and oil company representative(s). This operation is performed by pumping the fiber optic cable down the wellbore with mixed fluids until it reaches the first plug. Once the first plug is reached the cable communicates electronically with the electric power drilling device and drills out the plug. This process of pumping and drilling out plugs is repeated until all plugs have been drilled out. Once all of the plugs are drilled out, the unit will pull out of the wellbore, rig down from the well, move off of site, or over to the next adjacent well. This process takes up to 24 to 36 hours to completely perform on 24 hour operations.

All of the described processes take up a minimum of 24 hours or more to perform. All these described processes typically do not take place until 15 to 40 days after the well is fractured, thus leaving the well in a nonproducing state for a significant amount of time. Following is further discussion concerning some frac processes, and problems that may arise in connection with the performance of such processes.

For example, a Plug and Perf (PnP) process may be used in processes for hydraulic frac completions for oil and/or gas wells. The PnP process may use composite or dissolvable plugs. Multi-stage horizontal wells have been drilled and completed in shale formations around the world for decades, and account for nearly 90% of new wells drilled in the U.S. The PnP process is commonly used for completing most of these wells.

The PnP process inputs may be an electric line, perforating systems, ballistic setting tools, frac plug with ball, and pressure pumping using frac pumps. The process is to run the perforating guns, setting tool, and frac plug in one trip on electric line into the well. In the horizontal section, also referred to as a ‘lateral,’ the frac pumps assist by pumping the tools to the target location, that is, a flow of pressurized fluid is pumped into the well behind the tools to push the tools down to a desired location. At the target location, pumping stops, and the ballistic setting tool, or ‘ball,’ is actuated which sets and releases from the frac plug.

The perforating guns are then moved up-hole a short distance and the first of multiple clusters of perforating charges are fired, creating perforation tunnels which connect the casing to the adjacent shale rock. That is, the perforating charge may cause a perforation in the casing, and may also cause a fracture in the surrounding rock formation. The perforation and fracture may be such that any oil or gas flowing out of the fracture can pass into the casing by way of the perforation. After the perforating charges have been fired, the perforating gun, setting tool, and electric line may then be removed from the well. After this removal, the ball is pumped with the fracturing fluids to the frac plug. When the ball seats on the frac plug, those fluids are diverted at high rates and pressures into the perforations to enter, or cause, a fracture in the shale, creating pathways for oil or gas from the shale formation to flow to the well.

The PnP process is executed dozens of times in one well with expectations for the highest mechanical reliability. However, in many well completions the frac plug, setting tool, frac ball, and power charge are provided by different respective OEMs (Original Equipment Manufacturer) and may not interface or function correctly, thus disrupting or preventing downhole and above ground operations.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a Description of Time of Flight (TOF)/LiDAR tool (TLT) components, and example Time of Flight (TOF)/LiDAR tool {TLT) configuration.

FIG. 2 discloses a Map of Time of Flight (TOF)/LiDAR tool (TLT) survey results.

FIG. 3-7 disclose an example embodiment of utilization of Lidar during the perforation and frac'ing of oil and gas wells. The method is to cover all single and multi-stage lateral and vertical oil and/or gas well frac completions. Down Hole Tool (Archimedes)—Comprised of a CPU or Micro Processor, a Data Acquisition System, Internal Battery Pack(s), LIDAR or Laser Radar System(s), a module comprised of different sensors, and a Sub for connecting to the Perforation Gun or other downhole tools. Assembly—Uphole to Downhole—Wireline is connected to the Perforation Gun, a sub connection between the Perforation Gun and Archimedes, and a plug, packer, or sealing device for isolating the wellbore stages is connected to the downhole end of Archimedes. The assembly is connected to wireline and pumped down the well until reaching its designated depth. Once that depth is reached, stage 1, the plug, packer, or sealing system is deployed and the wellbore for stage 1 is isolated. (Archimedes can survey the wellbore during the pump down process. Surveying the entire length of the wellbore from surface to the end of the well.) Archimedes is powered on by signaling through wireline, or e-line, at the surface. This process can also be automated by use of an encoding device, a resolver, or accelerometer which will give an accurate understanding of distance traveled. Once powered on, if not powered by tethered wireline, or e-line, Archimedes begins to survey the entire interior, Inside Diameter, of the wellbore. Wireline begins to pull the assembly out of the wellbore as it signals the perf gun to begin firing its shape charges. This process is used to create perforations in the casing wall. As wireline pulls uphole, Archimedes detects motion and surveys the interior, inside diameter, of the wellbore when moving. All the charges have been fired, perforations made, and wireline continues to pull out of hole/wellbore. Survey of wellbore generated by Archimedes includes the following: Perforation Location; Perforation Orientation; Perforation Diameters; Perforation Depths/Penetration Depths of Perforations; Deformities in the casing wall; Inside Diameter measurements of the wellbore casing; Leaks in the casing wall. The perforation area, in any given stage, can vary in lengths, number of perforations, and variations. Wireline pulls the assembly out of the well. Archimedes is disconnected from the used perforation gun, the data is then transferred from Archimedes to a Host Server on the surface and uploaded to the cloud. Archimedes is then reset and programmed for the next stage of the frac. Archimedes is then connected onto the new assembly for continuing the completion process and commencing to the next stage until the entire lateral, or vertical, section of the wellbore is perforated and frac'd. The above survey data will be used to analyze the wellbore and allow the operator, or well owner(s), to make accurate and precise decisions on the amount of sand, chemical, and water that will be pumped during that stage. This information will help to improve frac optimization.

FIGS. 8-11 disclose an example embodiment of utilization of Lidar during casing integrity testing and frac preparation for oil and/or gas wells. This method is to cover all drilled, completed, and/or producing wells and/or nonproducing wells. Down Hole Tool (Archimedes)—Comprised of a CPU or Micro Processor, a Data Acquisition System (DAS), Internal Battery Pack(s), LIDAR or Laser Radar System(s), and a Sub for connecting to work string, tubing, coiled tubing, fiber optic cable/tubing, wireline, and/or other downhole tools or assemblies. Assembly—Archimedes is attached to wireline. Wireline and Archimedes is placed in the wellbore and pumped down the well. Once Archimedes and wireline have reached the end of the wellbore, or designated area, a signal from the surface is sent through the wireline to Archimedes and Archimedes is turned on. This process can also be automated by use of an accelerometer, encoding device, or resolver. Archimedes surveys the wellbore. Wireline begins to pull out of the well. Survey of wellbore generated by Archimedes includes the following: Collar locations; Leaks in the wellbore; Deformities; Path of deviation; Inside Diameter measurements of the wellbore casing. This survey is conducted throughout the entire wellbore. The above survey data will be used to analyze the wellbore and allow the operator, or well owner(s), to make accurate and precise decisions on how they will complete the well.

FIGS. 12-18 disclose an example embodiment of utilization of Lidar during surveillance of disposal and/or injection wells. 1. This method is to cover all disposal and/or injection wells. Down Hole Tool (Archimedes)—Comprised of a CPU or Micro Processor, a Data Acquisition System, Internal Battery Pack(s), LIDAR or Laser Radar System(s), and a Sub for connecting to work string, tubing, coiled tubing, fiber optic cable/tubing, wireline, and/or other downhole tools or assemblies. Archimedes is connected to work string, tubing, coiled tubing, fiber optic cable/tubing, wireline, and/or other downhole tools or assemblies. Archimedes battery pack(s) are activated, and Archimedes is turned on. This process can also take place down hole by use of frequency pulsing the tubular or wellbore. This process can also be automated for Archimedes to turn on, or activate, by use of an encoding device, resolver, or accelerometer while down hole, or inside the wellbore. This process is automated by detection of motion. Archimedes begins surveying the wellbore. Archimedes is run in the wellbore by use of hydraulic or electric workover equipment, rigs, or wireline. Archimedes is run, or pumped down, to the designated area in the well. The designated area can be the area where the perforations, or fracture, are located. Once there, fluid will be pumped from the surface at different pressures and rates. Archimedes surveys the designated area. Survey of wellbore generated by Archimedes includes the following: Collar locations; Leaks in the wellbore; Deformities; Diameter of perforations; Flow rate through perforations; Volume of fluid flowing through perforations; Temperature of the perforations; Inside Diameter measurements of the wellbore casing. The time it will take to survey the designated area will depend on the above survey data. Once complete, Archimedes is pulled out of the wellbore and the data is transferred to a Host Server. The above survey data will be used to analyze the wellbore and give the operator, or well owner(s), the opportunity to identify weak zones based on how much fluid was taken at which perforations(s), or fracture(s), and at what pressure these identified zones took that fluid. This will allow the operator, or well owner(s), to establish a rate map for these zones.

FIGS. 19-25 disclose an example embodiment of utilization of Lidar surveying enhanced oil and/or gas recovery wells. This method is to cover all producing and non-producing oil and gas wells in an enhanced oil and gas recovery field. Down Hole Tool (Archimedes)—Comprised of a CPU or Micro Processor, a Data Acquisition System, Internal Battery Pack(s), LIDAR or Laser Radar System(s), and a Sub for connecting to work string, tubing, coiled tubing, fiber optic cable/tubing, wireline, and/or other downhole tools or assemblies. Archimedes is connected to work string, tubing, coiled tubing, fiber optic cable/tubing, wireline, and/or other downhole tools or assemblies. Archimedes battery pack(s) are activated, and Archimedes is turned on. This process can also take place down hole by use of frequency pulsing the tubular or wellbore. This process can also be automated for Archimedes to turn on, or activate, by use of an encoding device, resolver, or accelerometer while down hole, or inside the wellbore. This process is automated by detection of motion. Archimedes is placed in the well and surveys the entire interior of the wellbore. Archimedes is run in the wellbore by use of hydraulic or electric workover equipment, rigs, wireline, or tractor application. Archimedes is pumped down or run down the wellbore to the end of the well (toe), or any designated area. Archimedes continues to survey the wellbore. The workover will begin pulling tubing out of the wellbore as Archimedes continues to survey the wellbore as it is pulled out of the hole from the designated area, or end of wellbore. This operation of pulling tubing out of the wellbore is performed only if wireline is not used to conduct the operation. Survey of wellbore generated by Archimedes: Collar locations; Leaks in the wellbore; Deformities; Diameter of perforations; Flow rate through perforations—injection rate out of the wellbore, or production rate coming into the wellbore; Volume of fluid flowing through perforations; Temperature of the perforations; Inside Diameter measurements of the wellbore casing. Archimedes is pulled out of the well. The above survey data will be used to analyze the wellbore and give the operator, or well owner(s), the opportunity to identify which perforation(s), or fracture(s), are producing. This will allow for an accurate understanding of how an operator, or owner(s), injection or flood field is flowing throughout the flood, or injection, reservoir. This will also allow for an operator, or owner(s), to produce a reservoir simulation of their flood and make a more accurate decision on how to flood the reservoir through injection wells and produce the reservoir through the production wells.

FIGS. 26-32 disclose an example embodiment of utilization of Lidar during re-stimulation, re-entry, and re-examination of old and new oil and gas wells. This method is to cover all drilled, completed, and/or producing wells and/or nonproducing wells. Down Hole Tool (Archimedes)—Comprised of a CPU or Micro Processor, a Data Acquisition System, Internal Battery Pack(s), a sensor module comprised of pressure, temperature, and composition sensing devices, LIDAR or Laser Radar System(s), and a Sub for connecting to work string, tubing, coiled tubing, fiber optic cable/tubing, wireline, and/or other downhole tools or assemblies. Archimedes is connected to work string, tubing, coiled tubing, fiber optic cable/tubing, wireline, and/or other downhole tools or assemblies. Battery pack one is turned on to power the sensing module. (The Battery pack may also be activated by motion detection. This motion can be identified by up-hole or downhole motion. When there is no movement, the battery pack(s) will power down until motion is detected again.) Archimedes is run in the wellbore by use of hydraulic or electric workover equipment, rigs, or wireline. Archimedes is run to the very bottom of the wellbore, or to any designated area in the well. Archimedes will be in standby mode (low power) and may activate (full power) when the tubular, or the wellbore, is frequency pulsed, pressure pulsed, or mud pulsed. This process can also be automated by use of an accelerometer, encoding device, or resolver. Once activated, Archimedes begins surveying the entire interior, Inside Diameter, of the wellbore. The workover will begin pulling tubing out of the wellbore as Archimedes continues to survey the wellbore as it is pulled out of the hole from the designated area, or end of wellbore. This operation of pulling tubing out of the wellbore is performed only if wireline is not used to conduct the operation. Survey of wellbore generated by Archimedes includes the following: Perforation Location; Perforation Orientation; Perforation Diameters; Which perforation, perforations, and/or fractured stages are producing; Which perforation, perforations, and/or fractured stages are not producing; Collar locations; Leaks in the wellbore; Deformities; Path of deviation; Inside Diameter measurements of the wellbore casing. Archimedes is pulled out of the wellbore and transfers data to a Host Server on the surface. The above survey data will be used to analyze the wellbore and allow the operator, or well owner(s), to make accurate and precise decisions on re-stimulating, or re-completing, their wellbore.

FIG. 33 discloses an example of an exploded view Lidar assembly.

FIG. 34 discloses an example of a Lidar assembly cross-section.

FIG. 35 discloses an example of a Lidar assembly.

FIG. 36 discloses an example of a laser to prism scan.

FIG. 37 discloses an example field of view.

FIG. 38 discloses an example operations diagram.

FIG. 39 discloses an example electric flow diagram.

FIG. 40 discloses an example prism mount.

FIG. 41 discloses an example laser and receiver mount.

FIG. 42 discloses an example laser and receiver.

FIG. 43 discloses an example control chassis module.

FIG. 44 discloses an example power pack module.

FIG. 45 discloses an example BHA connection sub.

FIG. 46 discloses an example full assembly.

FIGS. 48-50 disclose an example embodiment of utilization of Lidar in oil and/or gas wells for surveying production tubing and acquiring integrity data. This method will be used to acquire production tubing integrity data. Down Hole Tool (Archimedes)—Comprised of a CPU or Micro Processor, a Data Acquisition System (DAS), Internal Battery Pack(s), LIDAR or Laser Radar System(s), and a Sub for connecting to work string, tubing, coiled tubing, fiber optic cable/tubing, wireline, and/or other downhole tools or assemblies. Assembly—Archimedes is connected to a rope socket with a power connection switch to E-line or Wireline. Archimedes is then staged inside production tubing at the surface through a sub and TIW valve. Archimedes is both pressured and equalized inside the whole assembly. Wireline and Archimedes is then pumped down to the bottom of the production tubing. Once Archimedes and wireline have reached the end of the wellbore, or designated area, a signal from the surface is sent through the wireline to Archimedes and Archimedes is activated. Archimedes starts surveying the production tubing, then wireline begins to pull Archimedes out of the well. As Archimedes is pulled to the surface, it takes a 360 degree survey of the inside diameter of production tubing. The survey data acquired will be total length of each pipe of production tubing string, and generate the following: Collar locations; Leaks in tubing wall; Deformities; Inside Diameter measurements of production tubing. Data can be acquired with the tubing being dry, or having a full fluid column. This data will then be used to accurately provide which pipe of production tubing needs to be replaced. Once Archimedes is pulled out of the production tubing, data will be received. This data will be received via Wifi connection or direct USB sim card connection to the surface host.

### DETAILED DESCRIPTION OF SOME EXAMPLE EMBODIMENTS

Embodiments of the present invention generally relate to apparatus, systems, hardware, software, and computer-readable media concerning a downhole tool that may include LiDAR (Light Detecting And Ranging) functionality, and example embodiments also extend to methods for use of the downhole tool.

More particularly, some example embodiments of the invention may take the form of a Time of Flight (TOF)/LiDAR tool (TLT) that may be used to acquire data from, and concerning, the interior of underground cavities such as oil and gas wellbores for example. Note that the various tools disclosed herein, such as the TLT for example, may be employed in cased holes, as well as open holes that are uncased. The data may be acquired by the TLT using light emitted by a laser and/or other light source(s). Laser light may be particularly effective in some circumstances since a light beam emitted by a laser may remain highly coherent even over long distances, such as several thousand feet. In general, the light source may illuminate the interior of the casing, or open (uncased) hole, of the wellbore. Light reflected by one or more features in the interior of the casing or open hole may be received by one or more detectors, such as photodetectors for example.

Because different features, which may vary in their respective distances from the light source, may reflect the light differently, and at different times, the differences in return times of the reflected light may be used to create images, maps, and representations of features in the interior of the casing or whole. The return times may be measured since the time when the light was transmitted is known, and the time when reflected light is received at the detector is known.

### A. Example Materials and Environments for Some Embodiments

In general, embodiments of the invention, including a TLT, may employ a variety of different materials for their various components. Such materials may be particular well suited for use in underground mining and fracking operations where the materials may be exposed, for example, to any combination of high and low temperature extremes, corrosive materials, seawater, fluids, gases, fluid/gas/solids mixtures, high and low pressures, high noise levels, vibrations, concussions, explosions, shock waves, dust and other particulates, abrasive materials, flammable materials, and potentially explosive materials such as dust and gases. Examples of materials, which may be used in any combination, that may be employed in connection with a TLT and its various components may include, but are not limited to, titanium, the family of austenitic nickel-chromium-based superalloys that is sold under the registered mark INCONEL®, steel, copper, brass, aluminum, nickel, tungsten, ceramics, plastics, rubber, and composite materials which may include components such as, for example, carbon and carbon fibers. Any component(s) of the TLT may employ materials that are non-sparking, chemically inert, and/or have other properties compatible with conditions that could be encountered while the TLT is deployed. Finally, any suitable manufacturing process(es) may be used to produce components of the TLT and such processes include, but are not limited to, welding, brazing, milling, casting, molding, three dimensional (3D) printing/additive manufacturing, shaping, and cutting.

### B. Aspects of Example TLTs, Data Gathering, and Maps

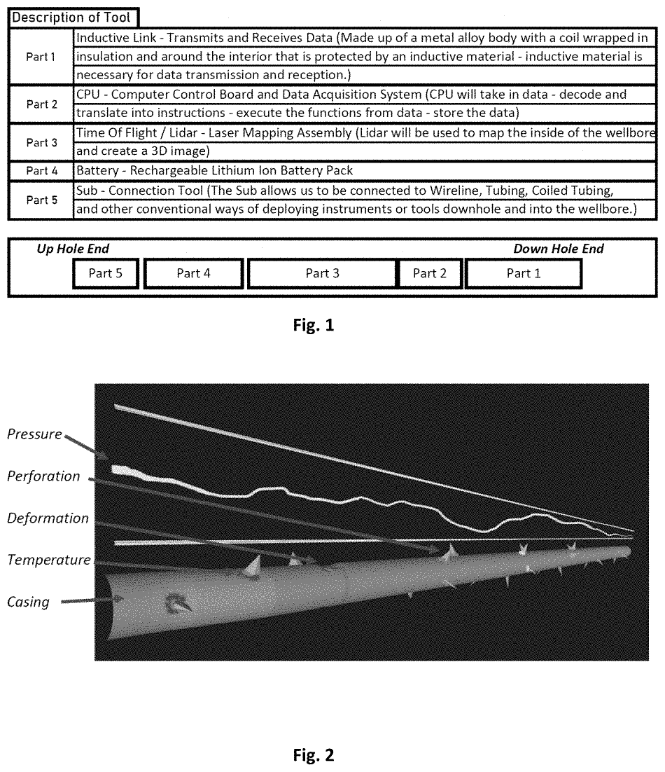

Various embodiments of a TLT may be used to gather the data used to generate results such as the map shown in FIG. 1. The gathering of data, by any means, method, and/or apparatus, concerning any aspect of an interior of a wellbore, whether that aspect is naturally occurring (such as a shale formation) or man-made (such as a casing, collar, fracture, or perforation or deformation of any kind), may be referred to herein as a ‘survey.’ Thus, the term ‘survey’ as used herein is intended to be broad in scope.

Any data gathered by a TLT may be stored at the TLT, transmitted from the TLT to a computing system on the surface, transmitted in real time even while the TLT is still downhole, and used by the TLT to create maps and/or enable other systems to create maps that can be stored at the TLT and/or transmitted to other systems such as computing systems on the surface. Note that embodiments of the invention may operate below the surface of the earth as well as in subsea environments, such as below the surface of an ocean bed for example, and in environments where a permafrost layer may be present at times.

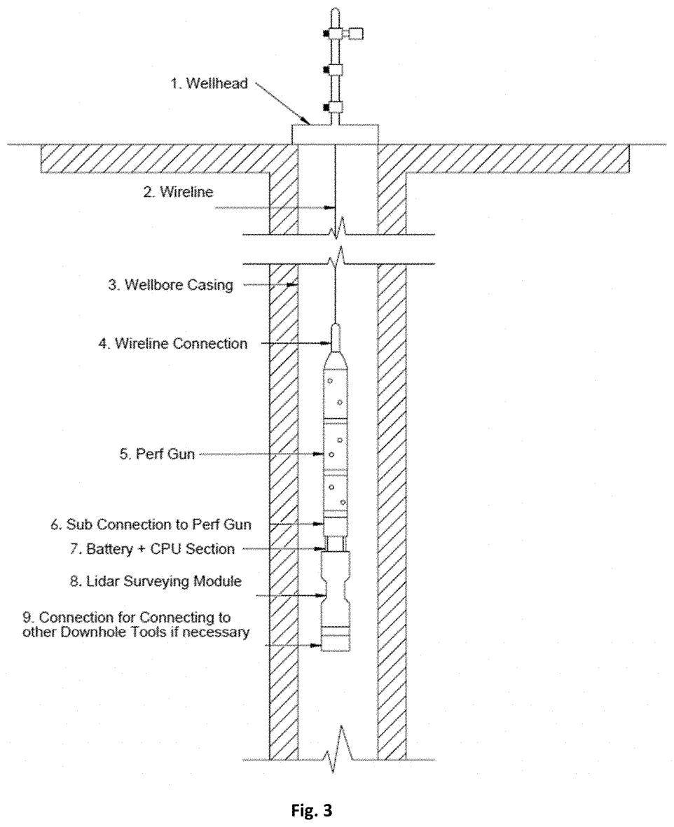

A schematic of an example embodiment of a TLT 100 is disclosed in FIG. 2. The TLT 100 may comprise a modular construction in which multiple components may be removably connected together in different combinations and different orders to define different implementations of a TLT 100 and/or other tools. In various embodiments, the TLT 100 may comprise video cameras and other cameras, as well as sensors operable to detect and report on conditions in the downhole environment. Such conditions may include, but are not limited to, high and low temperature extremes, corrosive materials, fluids, gases, fluid/gas/solids mixtures, high and low pressures, high noise levels, vibrations, concussions, explosions, shock waves, dust and other particulates, abrasive materials, flammable materials, and potentially explosive materials such as dust and gases.

In the example of FIG. 1, the TLT 100 may comprise five modules, or parts. Beginning at the downhole end, that is, the end of the TLT 100 that would enter the wellbore first when the TLT 100 is being deployed, the TLT 100 may comprise an inductive link 102. In general, the inductive link 102 may transmit and receive data, such as to/from computing systems and/or other equipment on the surface. The inductive link 102 may comprise a metal alloy body around which an electrically insulated coil is wrapped.

The TLT 100 may further comprise a CPU (Central Processing Unit) module 104 that may be releasably connected to the inductive link 102. The CPU module 104 may comprise a computer control board with one or more processors, and a data acquisition system. Among other things, the CPU module 104 may receive data, store and decode the data, translate the decoded data into instructions, and perform various functions by executing the instructions.

In addition, the TLT 100 may comprise a TOF/LiDAR laser mapping assembly (which may be referred to herein simply as a ‘LiDAR module’) 106 that may be releasably connected to the CPU module 104. In general, the TOF/LiDAR laser mapping assembly 106 may perform various functions including, but not limited to: light generation and transmission using one or more light sources, such as lasers for example; reflected light reception, such as by way of one or more detectors; TOF calculations for emitted/reflected light; and, map generation based on the calculated TOF. In some instances, the raw TOF information and other data collected by the TOF/LiDAR laser mapping assembly 106 may be uploaded to a system at the surface for post-processing and map generation. Additionally, or alternatively, the TOF/LiDAR laser mapping assembly 106 may generate one or more maps on-the-fly before the TLT 100 has been retrieved to the surface.

The TLT 100 may further comprise a power source module 108, such as a battery for example, other releasably connected to the TOF/LiDAR laser mapping assembly 106. No particular type of battery or power source is necessarily required and, in some embodiments, the power source module 108 may comprise a rechargeable lithium ion battery pack or other independent power source.

Finally, the up hole end of the TLT 100 may comprise a sub-connection tool 110 releasably connected to the power source module 108. In general, the sub-connection tool 110 may enable the TLT 100 to be connected to various different down-hole devices. For example, the sub-connection tool 110 may be configured to releasably connect to one or more of a wireline, tubing, coiled tubing, workover rig tubing, and a tractor.

As noted earlier, the components of a TLT may comprise any combination of modules, and with the possible exception of the sub-connection tool, the modules may be connected with each other in any order. Thus, the particular configuration shown in FIG. 1 is presented only by way of example and is not intended to limit the scope of the invention in any way.

With reference now to FIG. 2, an example of a map 200 is disclosed. As indicated, example maps may have a three dimensional (3D) appearance. In general, a map such as the map 200 may include, in various forms, information concerning any aspect of a downhole environment. Such aspects may include, but are not limited to, perforation locations, diameters of perforations, depths of perforations, leaks in a wellbore, any deformation to the wellbore casing, casing collar locations, and positive or negative fractures per each perforation made. As shown in the example map 200, a deformation of the casing may be displayed as part of the map, and the map may also indicate, for example, the physical configuration and dimensions of perforations made by a perf gun, and deformations in a wellbore casing.

Additionally, or alternatively, a map may, or may not, include information about conditions in the downhole environment, such as the pressure and temperature of fluids and gases in the downhole environment. Such information may take the form of graphs and/or other visual depictions of parameters such as pressure and temperature at various locations in the downhole environment. Any of the information included in a map may be displayed, in real time as the underlying data for the map is gathered for example, at an operator console on the surface that is in communication with the TLT.

With continued reference to FIGS. 1 and 2, following is a brief discussion of aspects of some example uses and applications according to various embodiments. In some instances, for example, a TLT may be employed in connection with a fracking process. Particularly, the TLT may be employed as a downhole wireline tool during the fracking process. The TLT may be attached to a perf gun and may operate to map part or all of the wellbore from surface to the toe, or bottom, of the well. When the perf guns fire and create holes or perforations in the casing wall, the LiDAR may be used to map features such as, but not limited to, the perforation locations, diameters of perforations, depths of perforations, leaks in wellbore, any deformations to the wellbore casing, and casing collar locations.

In another example, a TLT may be connected to, or incorporated in, a downhole drone, examples of which are disclosed in [Appendix A attached hereto and forming a part of this disclosure] which is incorporated herein in its entirety by this reference. As the drone moves downhole as part of a fracking process, the TLT may be used to map various aspects of the downhole configuration and environment such as, but not limited to, the perforation locations, diameters of perforations, depths of perforations, leaks in the wellbore, wellbore casing deformation, as well as indicating positive or negative fractures per each perforation made, and collar locations.

Another example use case concerns drill out and post-frac completion processes. In particular, a TLT may be used during, or after, the plug drill out and/or post-frac completion processes, to map various downhole features. The TLT may be attached to any of coiled tubing, workover rig tubing, wireline, or fiber optic cable, and used to map, and report on, downhole features such as, but not limited to, perforation locations, diameters of perforations, depths of perforations, leaks in the wellbore, deformation of the wellbore casing. As well, the TLT may be used during, or after, plug drill out and/or other post frac completion processes to identify, and report on, positive or negative fractures per each perforation made, and whether or not a perforation was adequate to enable fracking.

Still another illustrative use case for systems and devices of example embodiments concerns production processes. Particularly, a TLT may be used for production or well intervention planning logging. For example, the TLT may be deployed downhole by way of coiled tubing, workover rig tubing, wireline, or a tractor. The TLT may be used in vertical and/or horizontal sections of the well bore. While downhole, the TLT may obtain data concerning, for example, perforation locations, diameters of perforations, depths of perforations, leaks in the wellbore, deformation to the wellbore casing, as well as indicate positive or negative fractures per each perforation made, and whether or not a perforation was adequate in size, configuration, and positioning, to enable fracking. Such data may, for example, enable an oil or gas operator to make decisions concerning wellbore production optimization, future intervention, what types of post production completions may need to be done, what type of re-entry should be performed, and whether or not the well is a good candidate for intervention or stimulation.

A further use case for example embodiments concerns EOR (Enhanced Oil Recovery). In this case, the TLT may be used to map EOR fields or wellbores. The TLT may be deployed by way of coiled tubing, workover rig tubing, wireline, or a tractor. The TLT may be used in the vertical and/or horizontal sections of the well bore. Data gathered by the TLT may comprise, for example, information about which perforations/fractures are producing and what, gas or oil for example, the perforation or fracture is producing, and how much the perforation or fracture is producing. The amount being produced by a perforation or fracture may be measured by corresponding sensors of the TLT, or other modules, in terms of a mass flow rate (such as gallons per minute) and/or volumetric flow rate (such as cubic feet per second), for example. Note that as used herein, a perforation refers to a perforation of a casing, while a fracture refers to a fracture, break, or fissure, in a naturally occurring formation such as shale for example.

Finally, example embodiments of a TLT and/or one or more of its components may be used for interior pipeline inspections. In some particular embodiments, the TLT may be included as an element of a robotic device, drone, or pipeline pig, for example.

### C. Aspects of Some Example Methods

Embodiments of a TLT may be used to perform a variety of different methods. Following is a discussion of some non-limiting examples of such methods.

C.1 Hydraulic Fracturing Completions for Oil and/or Gas Wells

Some methods according to example embodiments may be implemented in single and multi-stage lateral and vertical oil and/or gas well frac completions. Various systems and devices may be employed in these methods. In one example implementation, a TLT may be employed that comprises a CPU and/or micro processor, a data acquisition system, internal battery pack(s), LiDAR or Laser Radar System(s), a module comprised of different sensors to detect and report on various downhole conditions, and a sub-connection tool for connecting to a perforation gun and/or other downhole tools. As noted elsewhere herein, the modules and components of a TLT may be arranged in various orders with respect to each other, and a TLT may itself be an element in a downhole string that includes one or more other components.

In one example implementation, such a downhole string may include several different components arranged, in order from uphole to downhole, such as a wireline connected to a perforation gun, a sub connection between the perforation gun and TLT, and a plug, packer, or sealing device for isolating the wellbore stages is connected to the downhole end of the TLT. In operation, this downhole string, or assembly, may be connected to a wireline and pumped down the well until reaching its designated depth. Once that depth is reached, stage 1, that is, the plug, packer, or sealing system, is deployed and the wellbore for stage 1 is isolated. The TLT may survey part or all the wellbore during the pump down process. In some instances, the entire length of the wellbore may be surveyed by the TLT during the pump down, from the surface to the toe of the well. The TLT may be powered on by, for example, signaling through wireline, or e-line, at the surface. This TLT power up process may also be automated by use of an encoding device, a resolver, or accelerometer which will give an accurate understanding of distance traveled. As noted, the TLT may include its own on board power supply, or may be powered by a power source in the downhole string that includes the TLT. Once powered on, whether by its own power source, a tethered wireline, or e-line, the TLT may begin to survey the entire interior of the inside diameter of the wellbore.

Next, the wireline may begin to pull the downhole string, or assembly, out of the wellbore as the wireline signals the perf gun to begin firing its shaped charges. This process is used to create perforations in the casing wall. As the wireline pulls uphole, the TLT may detect, such as with an accelerometer for example, the motion and begin to survey the interior, inside diameter, of the wellbore when the TLT is in motion. At some point, all the perforation charges have been fired, perforations made, and the wireline continues to pull out of the hole or wellbore.

The wellbore survey performed by the TLT may be performed during deployment and/or retraction of the TLT. In some example embodiments, the data gathered by the wellbore survey may comprise, but is not limited to, perforation locations, perforation orientation, perforation diameters, perforation depths, penetration depths of perforations, deformities in the casing wall, inside diameter measurements of the wellbore casing, and any leaks in the casing wall. Any of this data may be used to create a visually perceptible map, graph, or other rendering of the data. The perforation area, in any given stage, may vary in lengths, number of perforations, and variations.

After the wireline has pulled the assembly out of the wellbore, the TLT may be disconnected from the used perforation gun, and the survey data may then be transferred from the TLT to a host server and/or other computing system on the surface. In some instances, the survey data may be uploaded from the surface computing system, or TLT, to a cloud computing/storage site. After the survey has been completed, and the survey data provided to one or more recipients, the TLT may then be reset and programmed for the next stage of the frac process. The TLT may then be connected onto a new assembly, which may comprise different components than were included in the assembly that was initially pumped down, for continuing the completion process and commencing to the next stage until the entire lateral, or vertical, section of the wellbore has been perforated and fractured.

The survey data gathered during the performance of this example method may be used for a variety of purposes. For example, the data may be used to analyze the wellbore and allow the operator, or well owner(s), to make accurate and precise decisions on the amount of sand, chemical, and water, that will be pumped during a particular stage, or stages, of a frac process. This information may help to optimize fracking processes and results.

C.2 Re-Stimulation for Oil and/or Gas Wells

Some example methods according to one or more embodiments may be performed in connection with drilled, completed, and/or producing wells and/or nonproducing wells. Such methods may be performed using a downhole assembly that comprises a TLT. One embodiment of such a TLT may comprise a CPU and/or micro processor, a data acquisition system, internal battery pack(s), a sensor module comprised of pressure, temperature, and composition (of materials in the wellbore), sensing devices, LiDAR or Laser Radar System(s), and a sub-connection tool for connecting to a work string, tubing, coiled tubing, fiber optic cable/tubing, wireline, and/or other downhole tools or assemblies. The TLT may be connected, for example, to any one or more of a work string, tubing, coiled tubing, fiber optic cable/tubing, wireline, and/or other downhole tools or assemblies. Prior to deployment of the assembly downhole, the TLT battery pack may be powered on to power the sensors of the sensor module. In some embodiments, the battery pack may be activated by a motion sensor that detects uphole and/or downhole motion of the TLT. When there is no movement, the battery pack(s) may power down until motion is detected again.

The TLT may be run up and down the wellbore by use of hydraulic or electric workover equipment, rigs, or wireline, for example. Further, the TLT may be run to the very bottom of the wellbore, or to any designated area or location in the well. Until the TLT is in the location where surveying is to begin, the TLT may be in a standby mode (low power) and may activate (full power) when the tubular, or the wellbore, is frequency pulsed, pressure pulsed, or mud pulsed. Any of such pulses may be detected by a sensor of the TLT. The TLT activation process may also be automated by use of an accelerometer, encoding device, or resolver or other activation device.

Once activated, the TLT may begin surveying the entire interior, or only selected portions, of the inside diameter of the wellbore. In some example embodiments, the workover may begin pulling tubing out of the wellbore as the TLT continues to survey the wellbore as it is pulled out of the hole from the designated area, or end of wellbore. In some embodiments, the operation of pulling tubing out of the wellbore may be performed only if wireline is not used to conduct the operation.

The TLT may gather various types and amounts of data during performance of the wellbore survey. Such data may include, but is not limited to, perforation locations, perforation orientation, perforation diameters, which perforation, perforations, and/or fractured stages are producing (e.g., gas and/or oil), which perforation, perforations, and/or fractured stages are not producing, casing collar locations, leaks in the wellbore, deformities in the casing, path of deviation of the wellbore and/or casing, and, inside diameter measurements of the wellbore casing.

After the survey has been completed, the TLT may be pulled out of the wellbore and may then transfer the survey data, in raw and/or processed forms, to a host server on the surface. The survey data, in whatever form, may be used for a variety of purposes. For example, in some embodiments, the survey data may be used to analyze the wellbore and allow the operator, or well owner(s), to make accurate and precise decisions on re-stimulating, or re-completing, the wellbore.

C.3 Casing Integrity Testing and Frac Preparation for Oil and/or Gas Wells

One approach to casing integrity testing and frac preparation may employ an assembly that includes a gauge ring, CCL or collar locator, and caliper for analyzing the inside diameters of the wellbore casing. The assembly may be attached to a wireline, and the wireline and assembly pumped down the wellbore to a designated area in the wellbore. The gauge ring ensures that nothing will get hung up on the plug, packer, or sealing device(s) that are used during the fracking process, the CCL locates the collars of the casing, and the caliper may be used to identify anomalies, irregularities, or changes, in inside diameter of the wellbore casing, as well as identifying deformities in the casing wall. Once this process has been completed, the wireline begins pulling the assembly out of the wellbore, and after the wireline has been pulled completely out of the wellbore, the job is then complete.

Another approach, according to one or more example embodiments, may be employed in connection with drilled, completed, and/or producing wells and/or nonproducing wells. In this example approach, or method, the downhole system may comprise a TLT, which may include a CPU and/or microprocessor, a Data Acquisition System (DAS), internal battery pack(s), LiDAR or Laser Radar System(s), and a sub-connection tool for connecting to a work string, tubing, coiled tubing, fiber optic cable/tubing, wireline, and/or other downhole tools or assemblies. The TLT may be attached to a wireline, and the wireline and attached TLT may be placed in the wellbore and pumped down the well.

When the TLT and wireline have reached the end of the wellbore, or other designated area of the wellbore, a signal may be sent from the surface to the TLT by way of the wireline, and the signal may activate the TLT. In some embodiments, the activation process may be automatically initiated by use of an accelerometer, encoding device, or resolver. Where an accelerometer is used, for example, the accelerometer may detect motion of the TLT and then notify the system on the surface that the TLT is moving, thus causing the surface system to send the activation signal. In another example, the accelerometer may directly activate the TLT when the accelerometer detects motion of the TLT.

As the TLT is deployed and/or retrieved, the TLT may survey the wellbore. As part of the surveying process, or subsequent to it, the wireline may begin to pull out of the well until the wireline, TLT, and downhole assembly have been fully retracted from the wellbore. The survey may comprise the collection of a variety of data for part, or all, of the wellbore. Such data may include, but is not limited to, collar locations, leaks in the wellbore, deformities in the casing, a path of deviation of the wellbore and/or casing, and, inside diameter measurements of the wellbore casing. The collected data may be used for various purposes, such as to analyze the wellbore and enable the operator, or well owner(s), to make accurate and precise decisions as to whether, and how, they will complete the well.

C.4 Disposal and/or Injection Wells

Some embodiments of the invention are directed to methods that may be well suited for use with disposal and/or injection wells. Various systems and components may be employed in the performance such methods. For example, a TLT may be employed that comprises a CPU and/or micro processor, a data acquisition system, internal battery pack(s), LiDAR or Laser Radar System(s), and a sub-connection tool for connecting to work string, tubing, coiled tubing, fiber optic cable/tubing, wireline, and/or other downhole tools or assemblies.

In operation, the TLT may be connected to a work string, tubing, coiled tubing, fiber optic cable/tubing, wireline, and/or other downhole tools or assemblies. The TLT battery pack(s) may then be activated, and the TLT turned on. This startup process may also be implemented down hole by use of frequency pulsing the tubular, or wellbore. The startup process may also be automated for the TLT to turn on, or activate, by use of an encoding device, resolver, or accelerometer while down hole, or inside the wellbore. In some embodiments, the startup process may be automatically initiated by detection of motion of the TLT, such as by an accelerometer or other sensor of the TLT.

After startup, the TLT may begin surveying the wellbore. In some embodiments, the TLT may be run in the wellbore by use of hydraulic or electric workover equipment, rigs, or a wireline. The TLT, and any other devices to which it is connected, may be run, or pumped down, to a designated area in the wellbore, which may be any location in the wellbore. In some embodiments, one or more designated areas may be areas of the wellbore where the perforations, or fractures, are located. Once the TLT is in the desired location, fluid such as water and/or drilling fluid, for example, may be pumped from the surface into the wellbore at different pressures and rates. The TLT may then survey the designated area. The pressurized fluid may reveal various information about perforations, leaks, and deformities in the wellbore. For example, the survey may comprise the collection of a variety of data for part, or all, of the wellbore. Such data may include, but is not limited to, collar locations, leaks in the wellbore, deformities in the casing, diameter of perforations, flow rate through the perforations, the volume of fluid flowing through perforations, the temperature of the perforations and, the inside diameter measurements of the wellbore casing.

The time needed to complete the survey of the designated area may depend on the size of the designated area, and the amount and type of data to be collected. Once the survey has been completed, the TLT may be pulled out of the wellbore and the survey data transferred to a host server and/or other system.

The survey data collected by the TLT may be used for a variety of purposes. For example, the survey data may be used to analyze the wellbore and give the operator, or well owner(s), the opportunity to identify weak zones based on how much fluid was taken at which perforations(s), or fracture(s), and at what pressure these identified zones took that fluid. This information may enable allow the operator, or well owner(s), to establish a rate map for these zones, indicating what the flow rates are at different parts of the zone. The flow rates may provide an indication of the flow rate of gas and/or oil that might be achievable from the well.

C.5 Enhanced Oil and/or Gas Recovery Well Surveying

Various embodiments of the invention are directed to methods that may be well suited for use with enhanced oil and/or gas recovery well surveying such as, more particularly, with the surveying of producing and non-producing oil and gas wells in an enhanced oil and gas recovery field. A variety of systems and components may be employed in the performance of such methods. For example, a TLT may be employed that may comprise a CPU and/or micro processor, a data acquisition system, internal battery pack(s), LiDAR or Laser Radar System(s), and a sub-connection tool for connecting to work string, tubing, coiled tubing, fiber optic cable/tubing, wireline, and/or other downhole tools or assemblies.

Initially, the TLT may be connected to a work string, tubing, coiled tubing, fiber optic cable/tubing, wireline, and/or other downhole tools or assemblies. The TLT battery packs may then be activated, and the TLT turned on. This TLT startup process may take place on the surface, or downhole by use of frequency pulsing the tubular or wellbore. As well, the startup process may be automated. For example, the TLT may be activated by way of an encoding device, resolver, or accelerometer while downhole, or inside the wellbore. In some embodiments, the automated startup process may be initiated by a sensor, such as an accelerometer, that senses uphole and/or downhole motion of the TLT, and then activates the TLT in response to the sensed motion.

Once in the well, the TLT may survey part, or all, of the interior of the wellbore. The survey may be performed while the TLT is traveling down the wellbore, and/or while the TLT is being retracted from the wellbore. In some cases, part of a survey may be performed while the TLT is traveling down the wellbore, and another part of that survey may be performed while the TLT is traveling up the wellbore. More generally, no particular time for surveying, nor any particular scope of a survey, is required in any disclosed embodiment.

The TLT may travel to any part of the wellbore in connection with performance of a survey. For example, the TLT may travel to the toe of the well and/or to one or more intermediate locations in the wellbore. In some embodiments, the TLT may be run in the wellbore by use of hydraulic or electric workover equipment, rigs, wireline, or tractor application. In other embodiments, the TLT may be pumped down the wellbore to the end of the well, and/or any other designated area in the wellbore.

Depending upon the embodiment, the workover may begin pulling tubing out of the wellbore even as the TLT continues to survey the wellbore as it is pulled out of the hole from the designated area, or end of wellbore. In some embodiments, the operation of pulling tubing out of the wellbore may be performed only if wireline is not used to conduct the survey operation.

Performance of the survey by the TLT may include gathering data concerning a variety of different aspects of a downhole environment. For example, the survey data may include, but is not limited to, collar locations, size and location of leaks in the wellbore, size, configuration, and location, of casing deformities, the diameter, configuration, and orientation, of perforations, a gas or fluid flow rate through perforations, an injection rate of fracking fluid out of the wellbore and into the formation, or production rate of oil and/or gas coming from the formation into the wellbore, volume of fluid flowing through the perforations, the temperature of the perforations, and inside diameter measurements of the wellbore casing. After completion of the survey, the TLT and any other devices or assemblies may be retracted from the wellbore.

The data gathered during the survey may be used for a variety of purposes. For example, the survey data may be used to analyze the wellbore and give the operator, or well owner(s), the opportunity to identify which perforation(s), or fracture(s), are producing. This will allow for an accurate understanding of how an operator, or owner(s), injection or flood field is flowing throughout the flood, or injection, reservoir. This will also allow for an operator, or owner(s), to produce a reservoir simulation of their flood and make a more accurate decision on how to flood the reservoir through injection wells and produce the reservoir through the production wells.

### D. Aspects of Some Example Use Cases

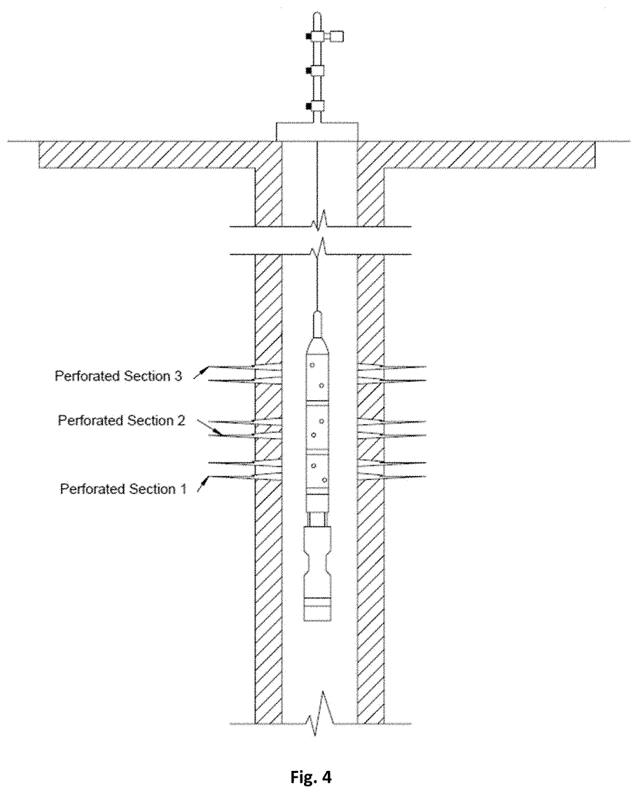

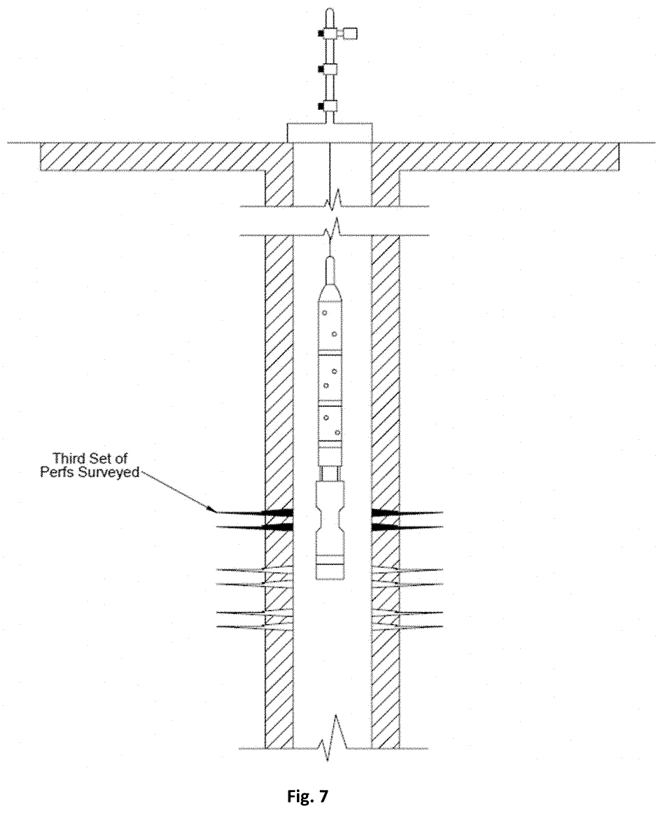

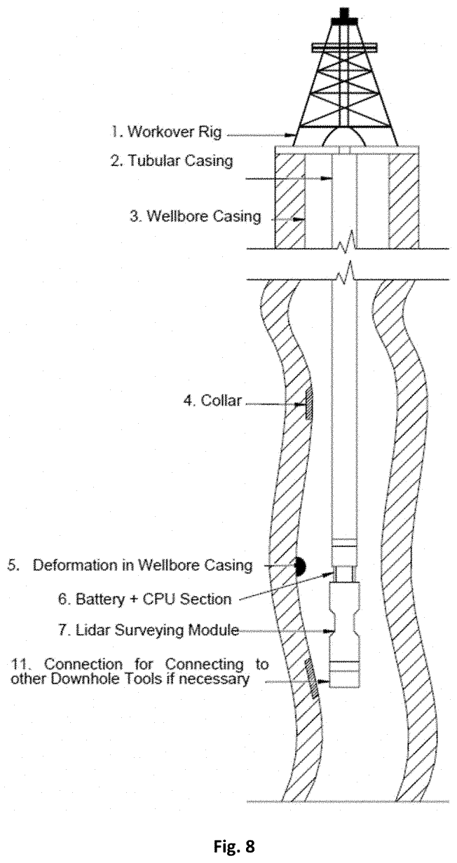

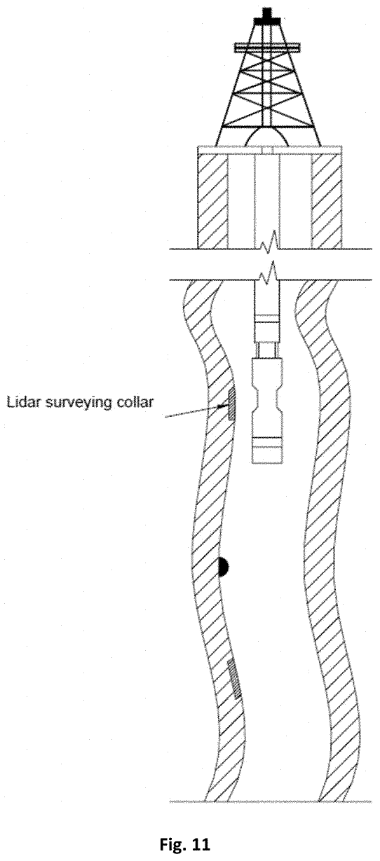

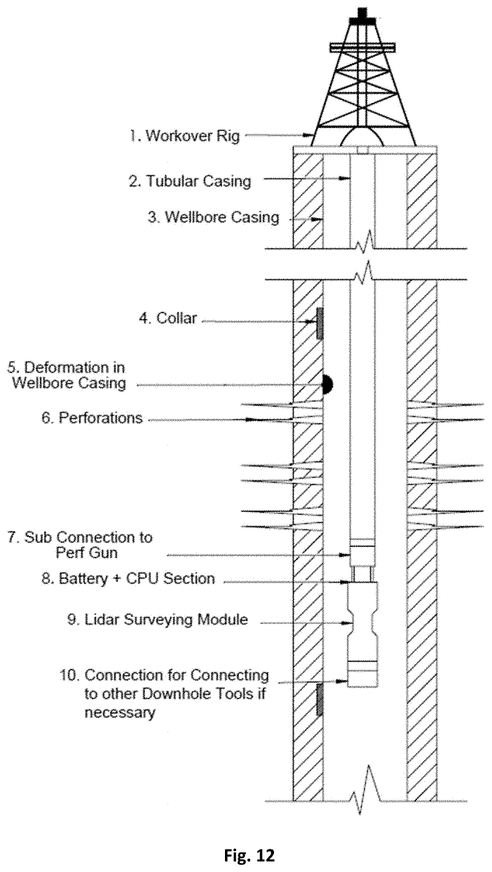

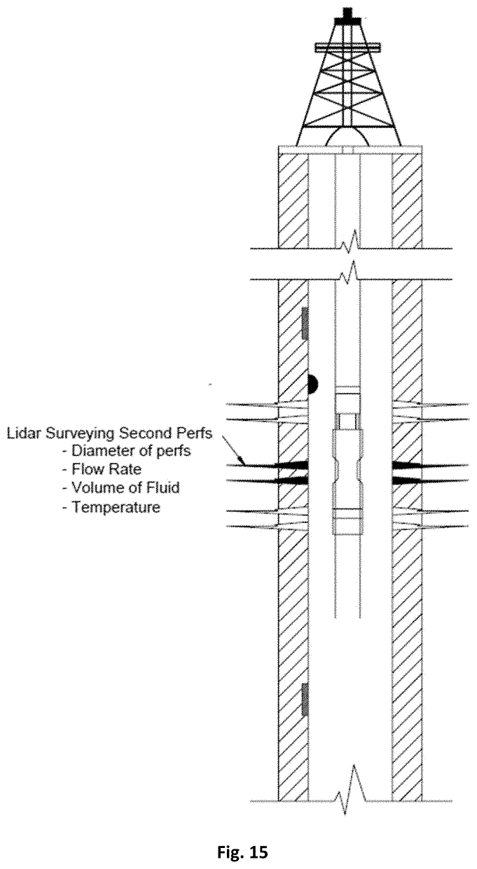

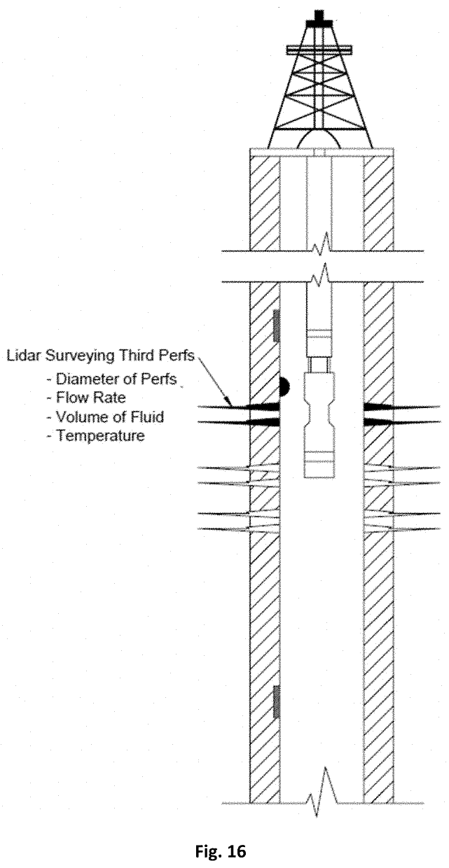

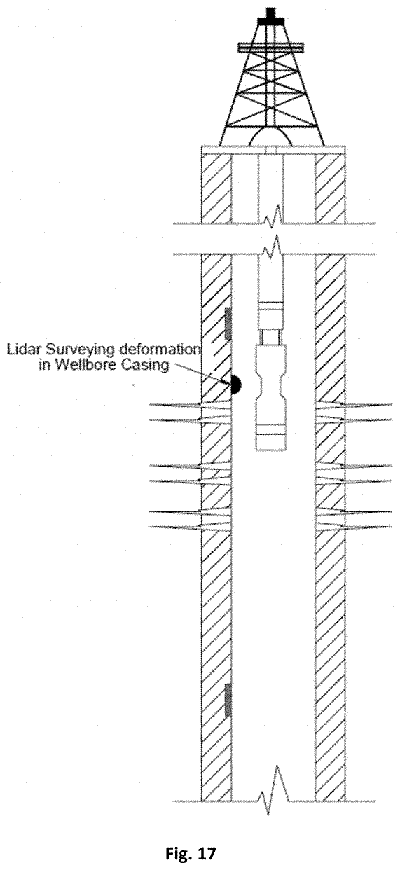

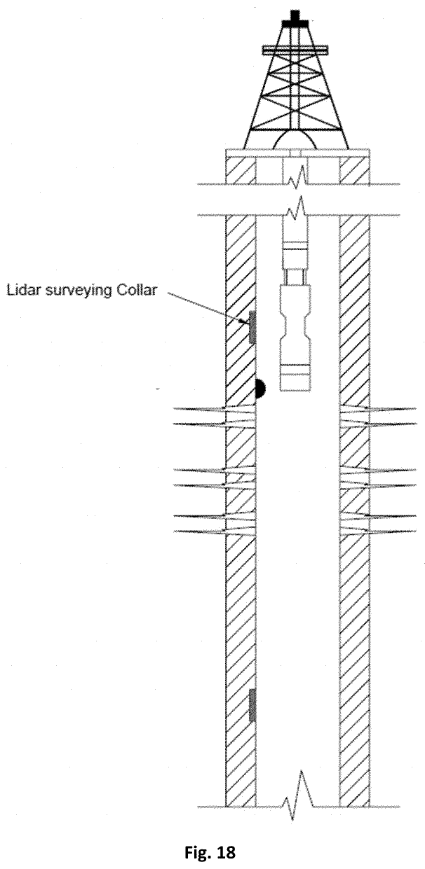

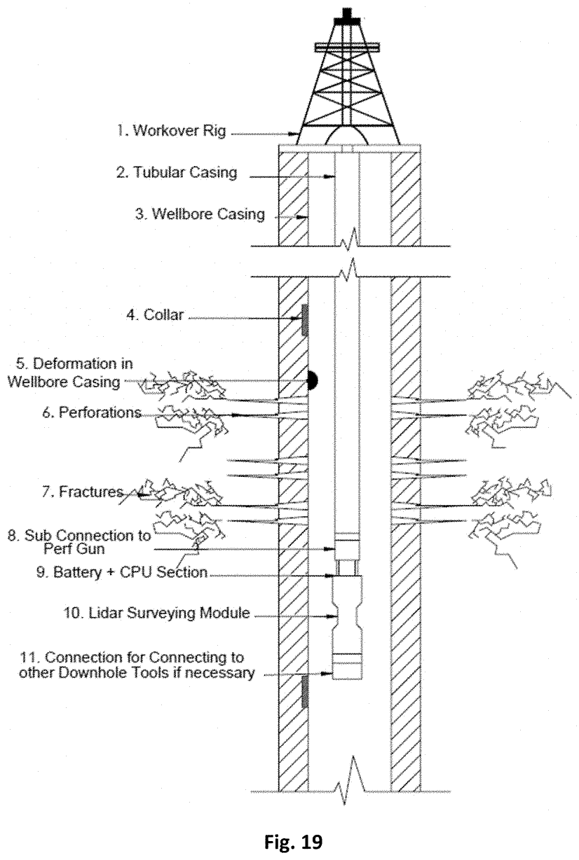

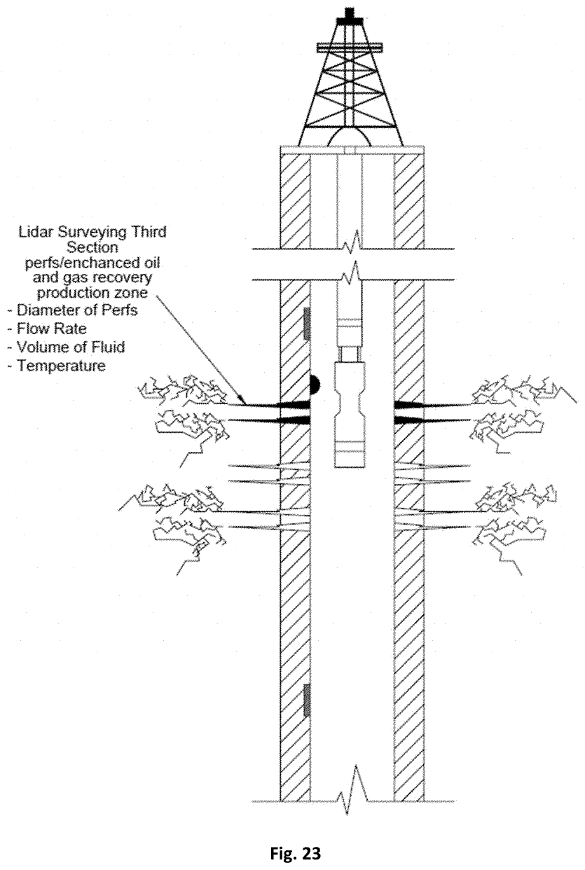

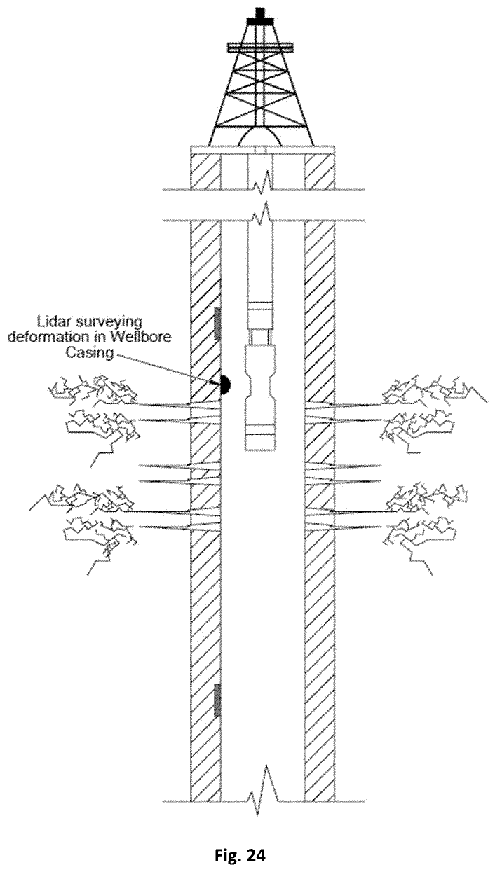

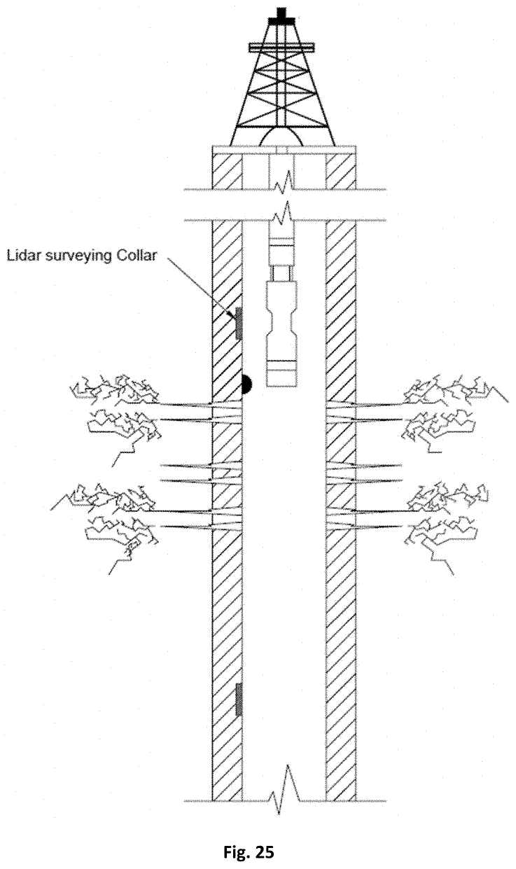

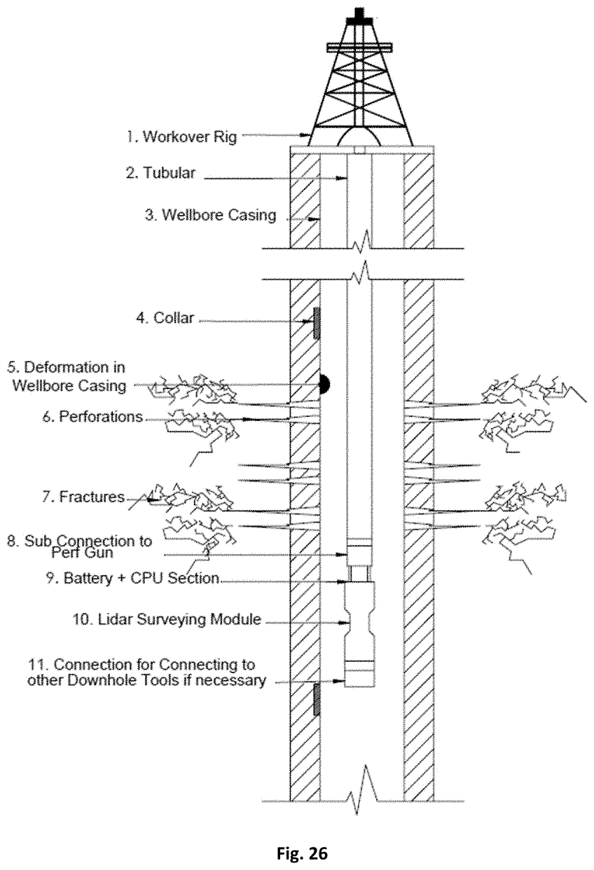

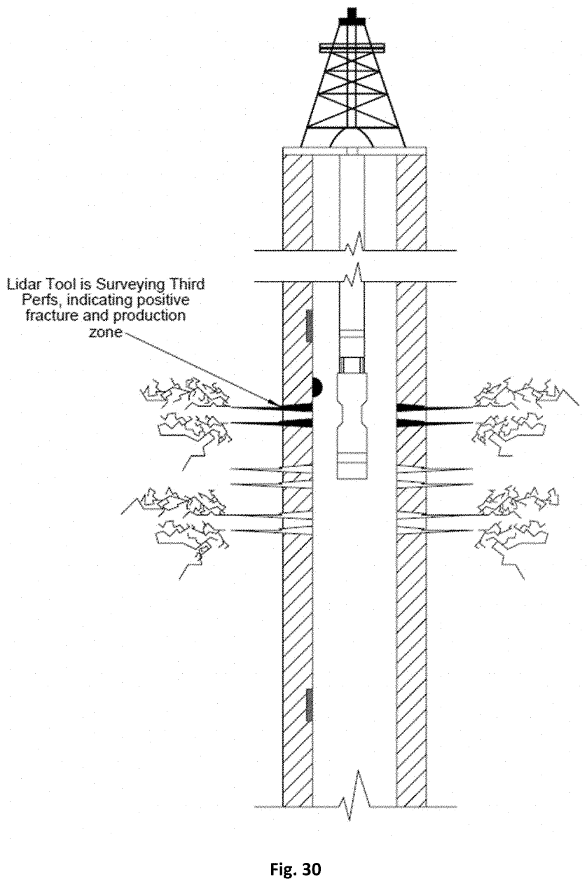

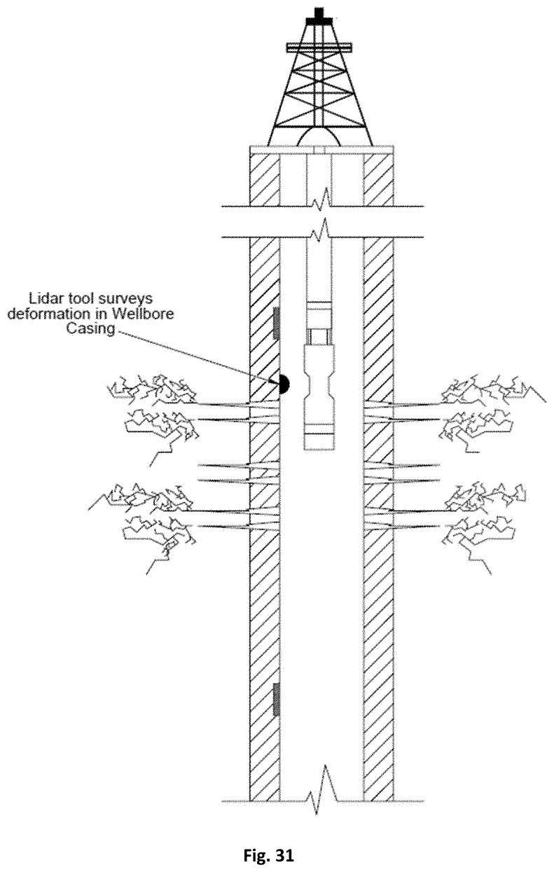

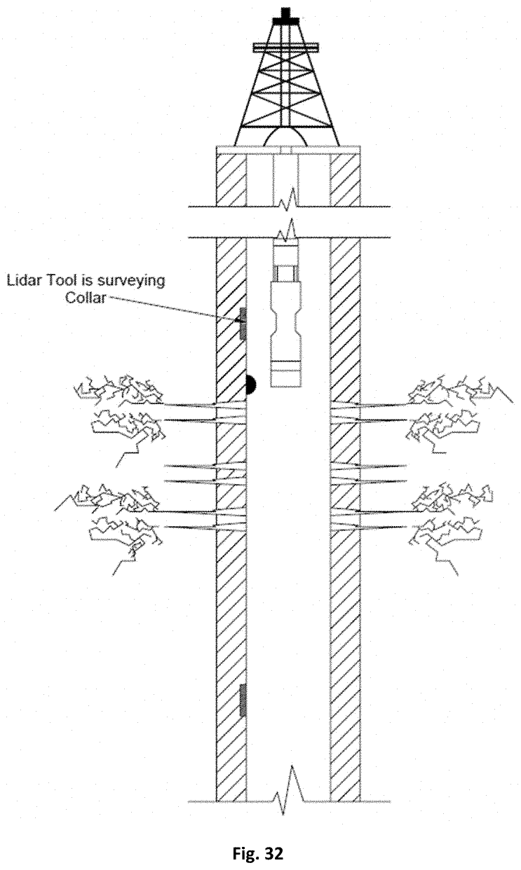

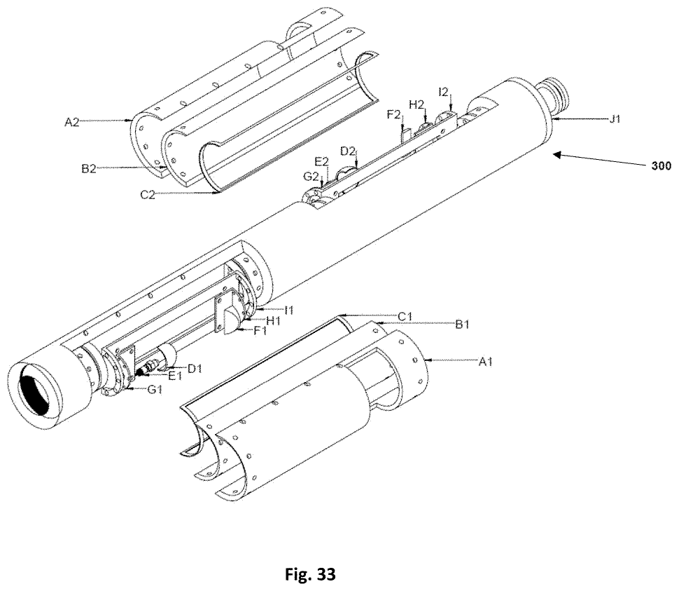

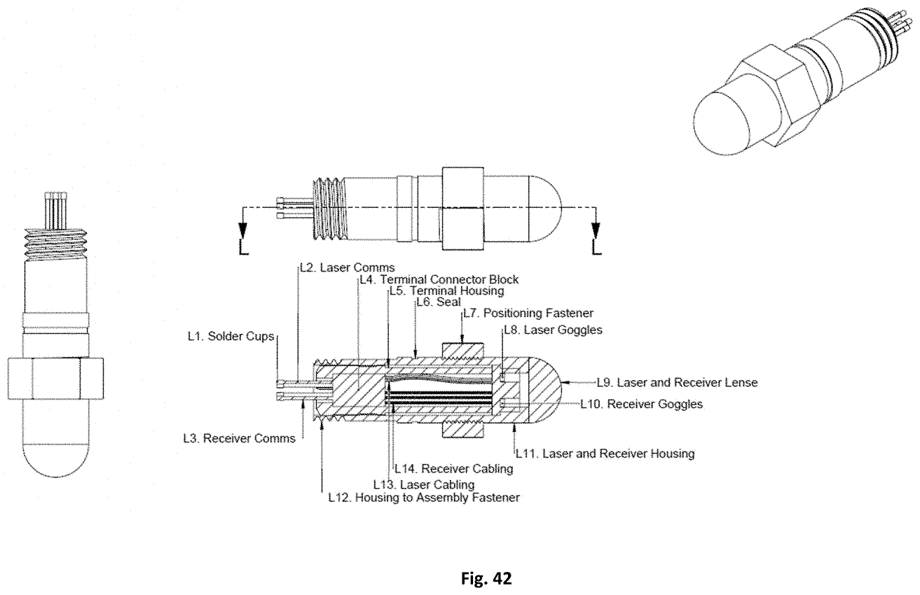

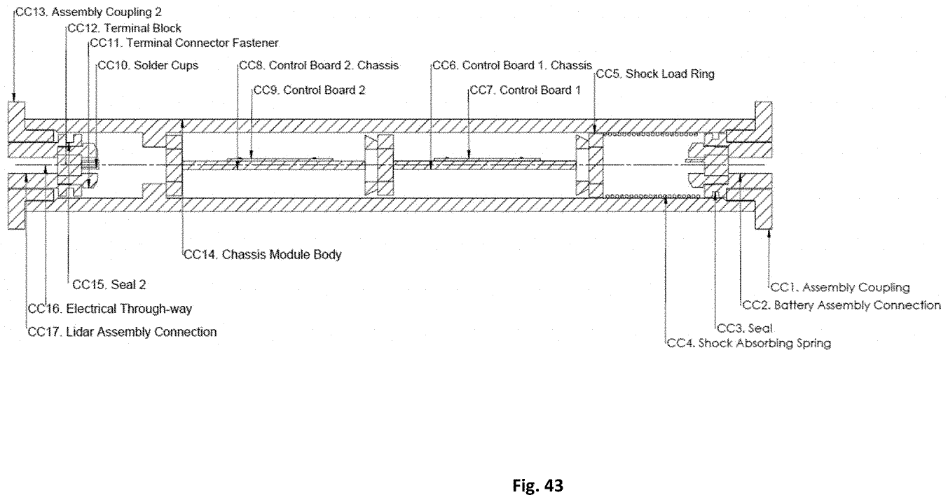

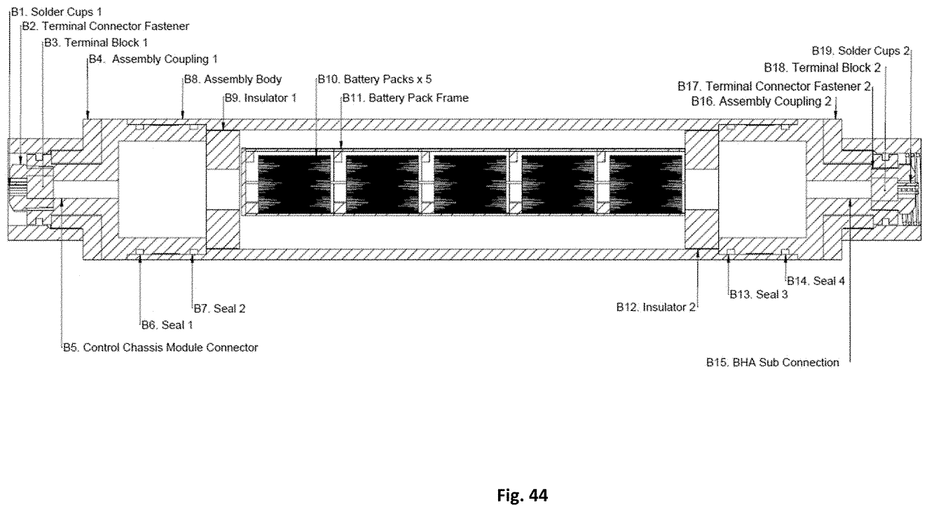

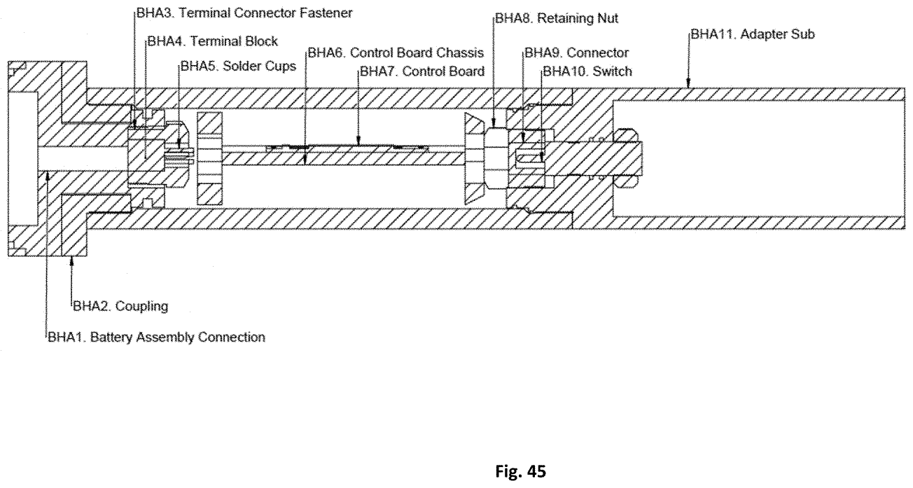

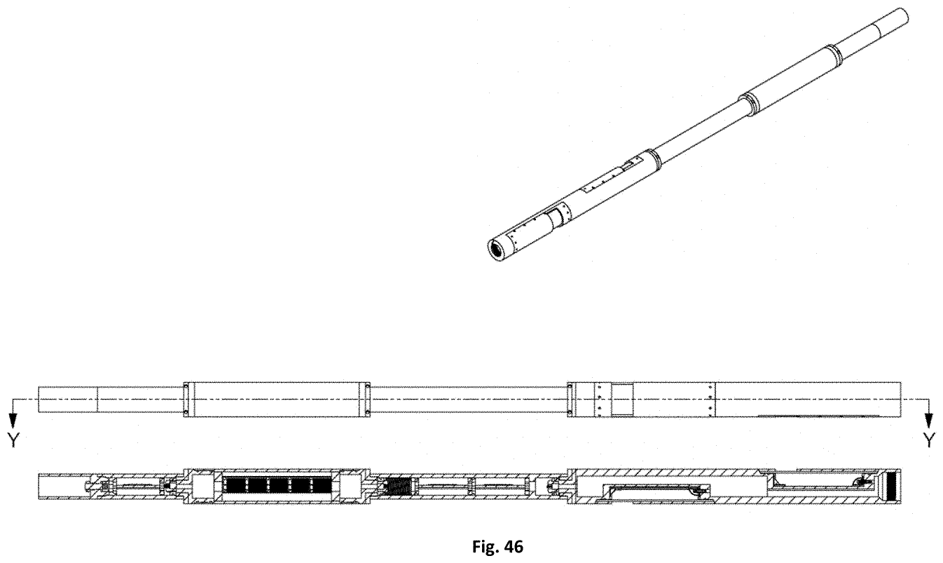

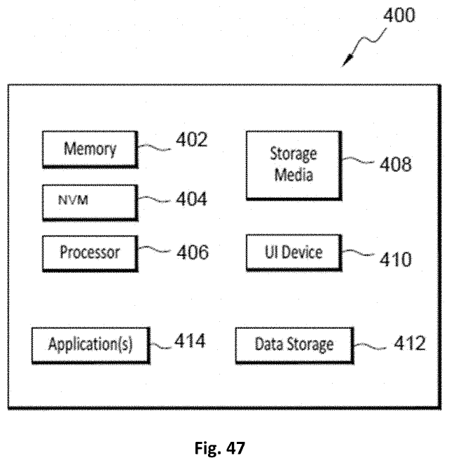

With reference next to FIGS. 3-46, further details are provided concerning some example use cases, and associated apparatuses and methods, for some embodiments of the invention.

D.1 Perforation and Fracking of Oil and Gas Wells

Turning now to FIGS. 3-7, an example embodiment of a TLT is disclosed that comprises a downhole perf gun assembly and a LiDAR module that may be used to survey any aspect of the interior of the wellbore casing, such as a wellbore casing of an oil or gas well for example. A survey may be performed before, during, and/or, after the perf gun has been fired. In the example of FIG. 3, the perf gun assembly has been deployed downhole in the casing in preparation for firing of the perf gun. Thus, in the example of FIG. 3, no perforations are indicated in the casing. Finally, FIG. 3 outlines an example method which may be employed for the perforation and fracking of oil and gas wells, as disclosed in the examples of FIGS. 3-7. Note that reference in the Figures to ‘Archimedes’ refers to example embodiments of a TLT as disclosed elsewhere herein.

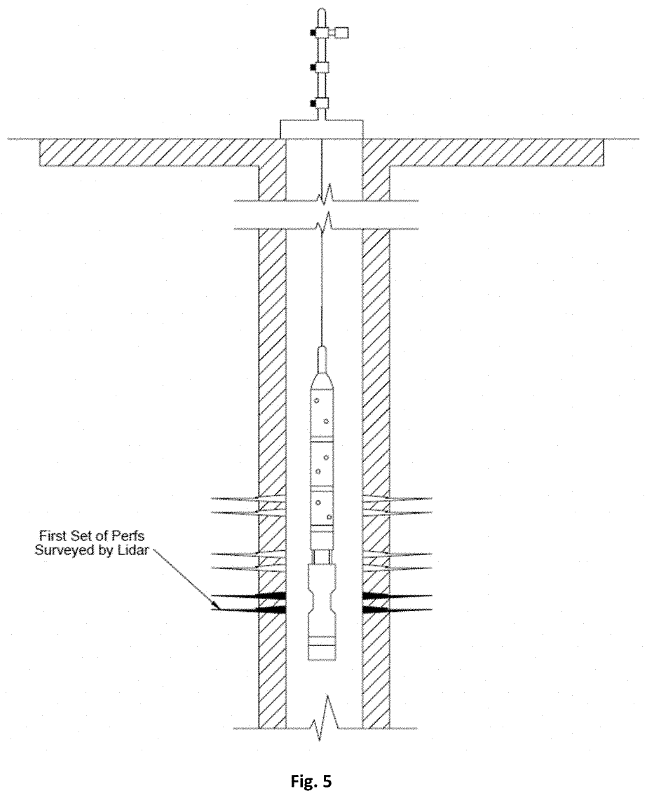

Turning next to FIG. 4, it can be seen that the perf gun has been positioned at the desired location. In the example of FIG. 4, it can be seen that the LiDAR module is positioned downhole of the perf gun. Once positioned, the perf gun may then be fired, creating perforations in the casing, as well as cracks in the surrounding formation in which the well has been drilled. The perforations in the casing may be in communication with the cracks in the surrounding formation such that fluids and/or gases, which may be pressurized, in the formation may enter the well casing by way of the cracks and perforations. In some use cases, the surrounding formation may comprise oil shale and/or other rocks and minerals. However, no use case disclosed herein is necessarily limited to any particular formation, or formation type/material.

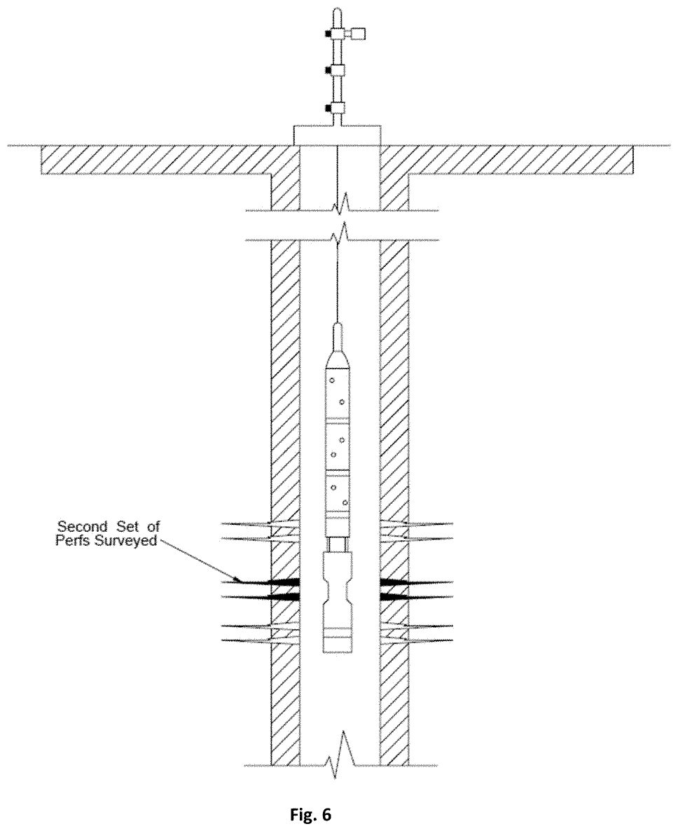

As indicated collectively by FIGS. 5, 6, and 7, the LiDAR module may be moved uphole, successively surveying the perforations, beginning with the perforations that are furthest downhole and ending with the perforations nearest the surface. This may be a particularly efficient way to perform the survey since the survey may be performed as the wireline is retrieving the TLT back to the surface. In other embodiments, part or all of a survey, which may or may not involve surveying perforations, may be performed as the TLT is being deployed downhole and/or is being retrieved to the surface.

D.2 Casing Integrity Testing and Frac Prep for Oil and Gas Wells

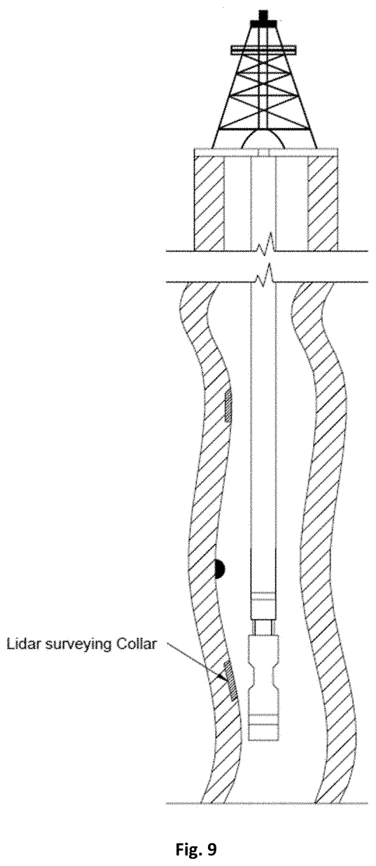

FIG. 8-11 disclose an example embodiment of a TLT that comprises a LiDAR module that may be used to survey any aspect of the interior of the wellbore casing, such as a wellbore casing of an oil or gas well for example. As shown in the example of FIG. 8, a wellbore casing may have various deformities and other irregularities whose presence and characteristics may need to be determined. As well, there may be a need to survey and inspect one or more collars and/or other components of the casing. These determinations may be made, and inspections may be performed, using a TLT, examples of which are disclosed herein. In the example of FIG. 8, the downhole device may be configured primarily as a surveying and data collection instrument and, as such, may omit a perf gun and other components not directly involved in the surveying operations.

As indicated in FIG. 8, the TLT may be connected to a workover rig by tubing or other device(s), and may be deployed downhole to a desired location. Thus positioned, the TLT may perform a survey of the casing as the workover rig retrieves the TLT from the well. Finally, FIG. 8 outlines an example method which may be employed for the surveying of a well, as disclosed in the examples of FIGS. 8-11.

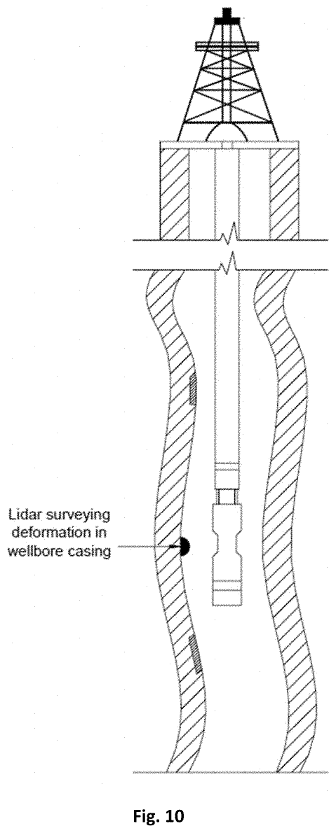

FIGS. 9, 10, and 11, collectively indicate how the LiDAR module may be moved uphole, surveying the casing to identify, and record the locations of, one or more casing collars, one or more casing deformations, and/or one or more other downhole features. The survey may begin at the location to which the TLT was initially deployed, and may be performed as the TLT is retrieved from the well by the workover rig.

D.3 Surveillance of Disposal and/or Injection Wells

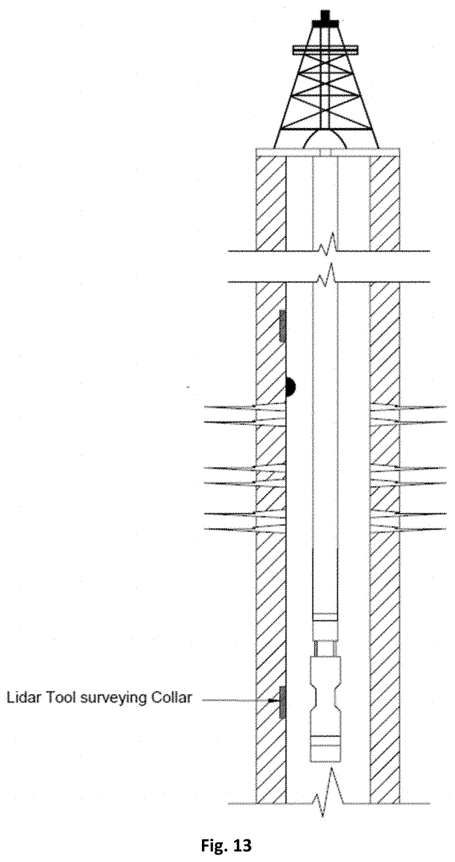

Turning next to FIGS. 12-18, embodiments of a TLT may be used to survey disposal and/or injection wells. Such surveys may identify, locate, and gather information concerning the characteristics of, collars, perforations, and deformations, for example. As well, such surveys may gather information concerning perforation characteristics including, but not limited to, diameter of the perforation, flow rate through the perforation, pressure of the flow through the perforation, and the temperature of fluids and/or gases flowing through the perforation. As well, FIG. 12 outlines an example method which may be employed for the surveying of a well, as disclosed in the examples of FIGS. 12-18.

The example TLT of FIGS. 12-18 may include a LiDAR module and may be attached to a sub-connection to a perf gun, for example. As shown in the Figures, the TLT may be connected to a workover rig by tubing or other device(s), and the TLT may be deployed downhole, and retrieved, by the workover rig. Initially, the TLT may be located at a desired position in the wellbore and then, as the TLT moves uphole during retrieval by the workover rig, the TLT may survey the downhole environment. In some embodiments, the survey may gather data concerning any one or more of collars, casing deformations, and perforations. Examples of such data include, but are not limited to, the perforation fluid and fluid characteristics noted above.

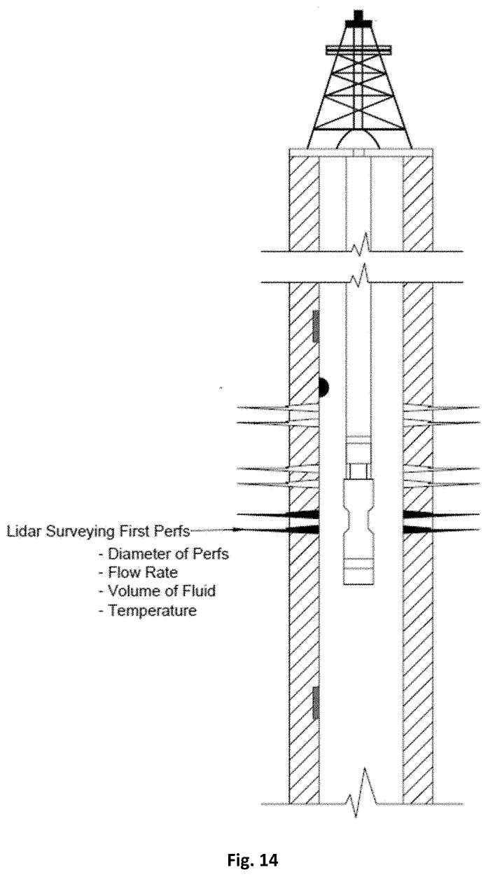

FIGS. 13, 14, 15, 16, 17 and 18, collectively indicate how the LiDAR module of the TLT may be moved uphole, surveying the casing to identify, and record the locations and physical characteristics of, one or more casing collars, one or more casing deformations, one or more perforations, and/or one or more other downhole features. The survey may begin at the location to which the TLT was initially deployed, and may be performed, in whole or in part, as the TLT is retrieved from the well by the workover rig. Part or all of the survey may alternatively be performed as the TLT is being deployed downhole.

D.4 Surveillance of Enhanced Oil and Gas Recovery Wells

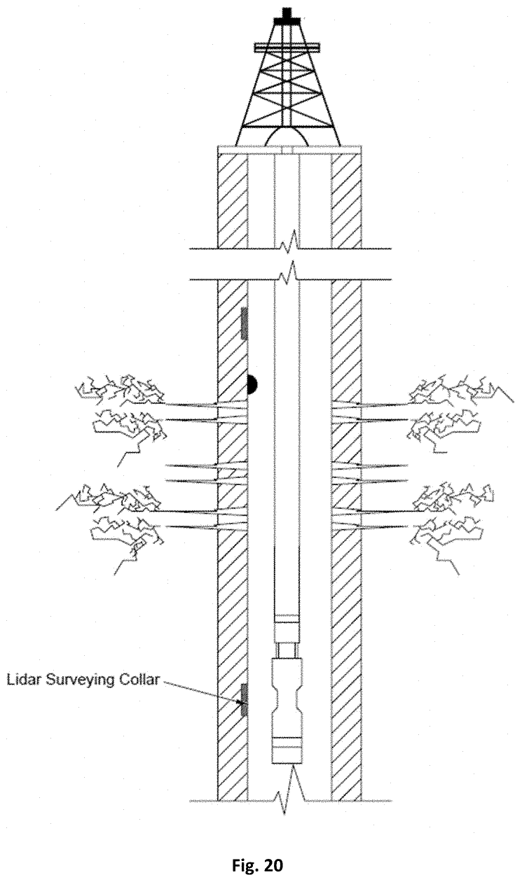

As indicated in FIGS. 19-25, embodiments of the invention may be employed in the surveillance of enhanced oil and gas recovery wells. Such surveys may identify, locate, and gather information concerning the characteristics of, collars, perforations, and deformations, for example. As well, such surveys may gather information concerning perforation characteristics including, but not limited to, diameter of the perforation, flow rate through the perforation, pressure of the flow through the perforation, and the temperature of fluids and/or gases flowing through the perforation. As well, FIG. 19 outlines an example method which may be employed for the surveying of a well, as disclosed in the examples of FIGS. 19-25.

The example TLT of FIGS. 19-25 may include a LiDAR module and may be attached to a sub-connection to a perf gun, for example. As shown in the Figures, the TLT may be connected to a workover rig by tubing or other device(s), and the TLT may be deployed downhole, and retrieved, by the workover rig. Initially, the TLT may be located at a desired position in the wellbore and then, as the TLT moves uphole during retrieval by the workover rig, the TLT may survey the downhole environment. In some embodiments, the survey may gather data concerning any one or more of collars, casing deformations, and perforations. Examples of such data include, but are not limited to, the perforation fluid and fluid characteristics noted above.

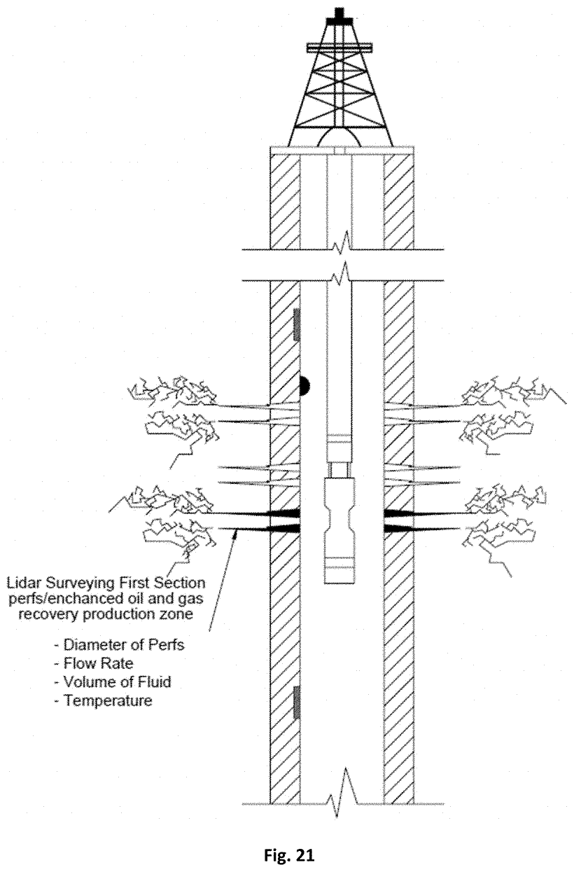

FIGS. 20, 21, 22, 23, 24 and 25, collectively indicate how the LiDAR module may be moved uphole, surveying the casing to identify, and record the locations and physical characteristics of, one or more casing collars, one or more casing deformations, one or more perforations, and/or one or more other downhole features. The survey may begin at the location to which the TLT was initially deployed, and may be performed, in whole or in part, as the TLT is retrieved from the well by the workover rig. Part or all of the survey may alternatively be performed as the TLT is being deployed downhole.

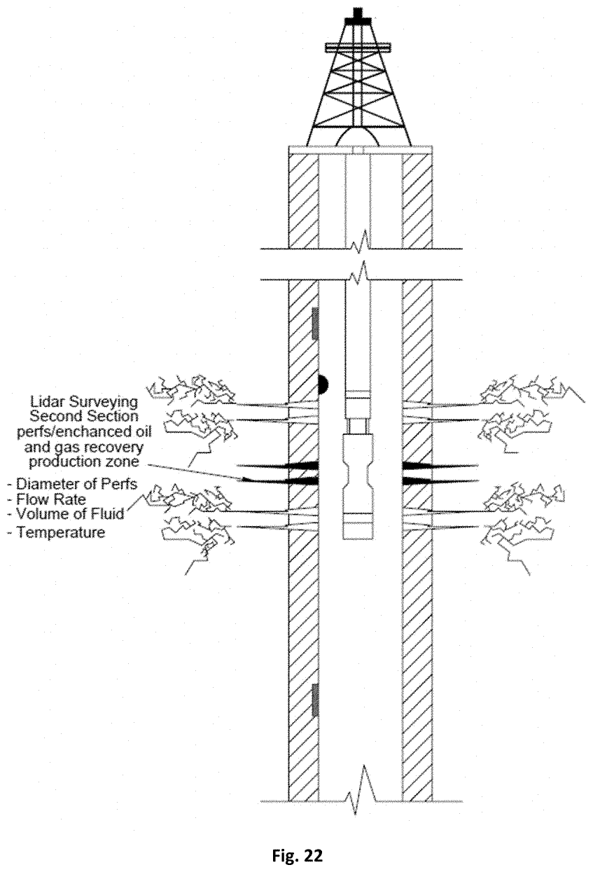

With particular reference to FIGS. 21, 22, and 23, embodiments of the invention may involve surveying perforations, among other things, in one or more enhanced oil and gas recovery production zones. By surveying these enhanced recovery zones, data may be gathered that indicates how productive the zones are. Such productivity may be expressed in terms of fluid and gas flow rates, for example.

D.5 Re-Stimulation, Re-Entry, and Re-Exam, of Old and New Wells

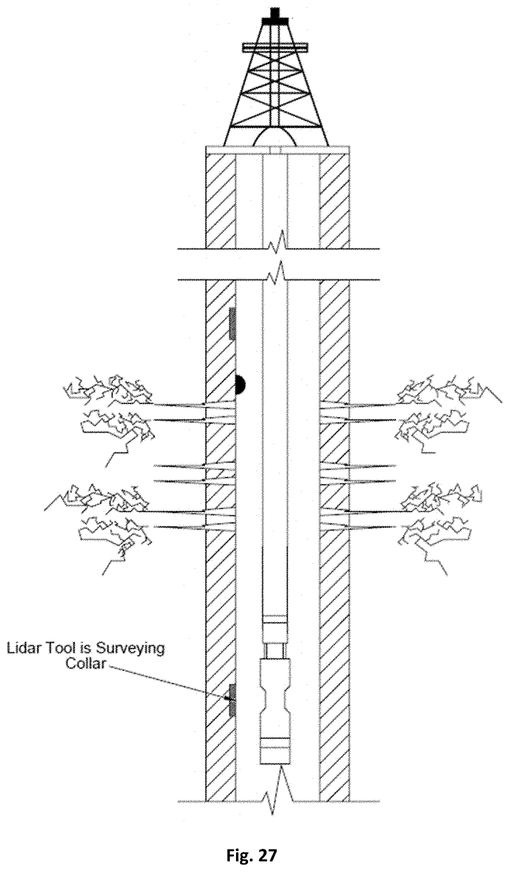

With reference now to FIGS. 26-32, example methods within the scope of the invention are disclosed, where such methods may concern, for example, surveys performed in connection with the restimulation, reentry, and reexamination, of both old and new wells, such as oil and/or gas wells for example. Such surveys may identify, locate, and gather information concerning the characteristics of, perforations, fractured areas of the formation, and unfractured areas of the formation. That is, in some cases, the perf charges may succeed in perforating the casing but may not necessarily cause a corresponding fracture in the portion of the formation near the casing perforation. FIG. 26, in particular, outlines an example method which may be employed for the surveying of a well, as disclosed in the examples of FIGS. 26-32. Typically, although not necessarily always, there is a layer of cement between the steel of the casing pipe that is being perforated, and the rock of the formation. Thus, preparation for a successful frac job may require that both the casing and the cement be perforated so as to create a flow path for the frac fluids to be pumped at pressure to crack the formation rock and allow oil and/or gas to flow.

The example TLT of FIGS. 26-32 may include a LiDAR module and may be attached to a sub-connection to a perf gun, for example. As shown in the Figures, the TLT may be connected to a workover rig by tubing or other device(s), and the TLT may be deployed downhole, and retrieved, by the workover rig. Initially, the TLT may be located at a desired position in the wellbore and then, as the TLT moves uphole during retrieval by the workover rig, the TLT may survey the downhole environment. In some embodiments, the survey may gather data concerning any one or more of collars, casing deformations, and perforations. Examples of such data include, but are not limited to, the perforation fluid and fluid characteristics noted above.

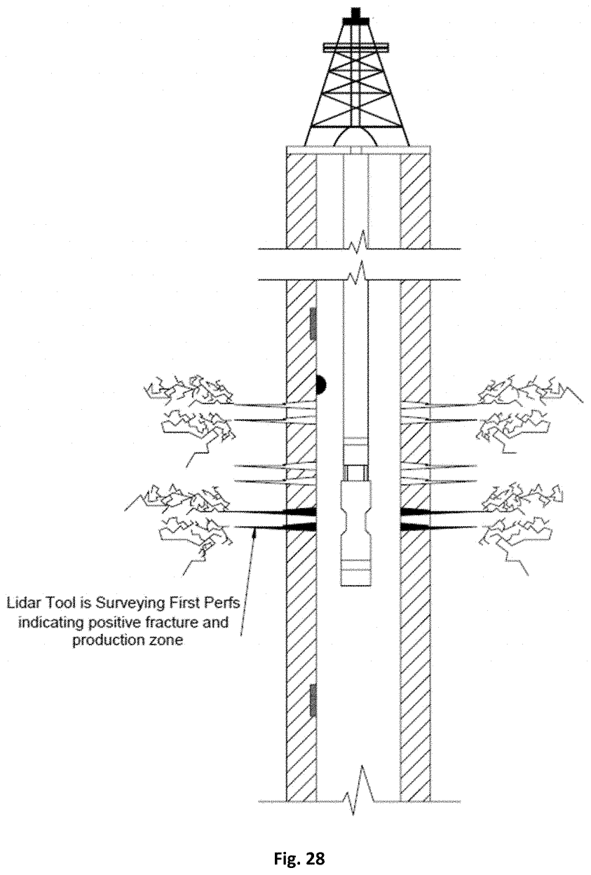

FIGS. 27-32, collectively indicate how the LiDAR module may be moved uphole, surveying the casing to identify, and record the locations and physical characteristics of, one or more casing collars, one or more casing deformations, one or more perforations, and/or one or more other downhole features. The survey may begin at the location to which the TLT was initially deployed, and may be performed, in whole or in part, as the TLT is retrieved from the well by the workover rig. Part or all of the survey may alternatively be performed as the TLT is being deployed downhole.

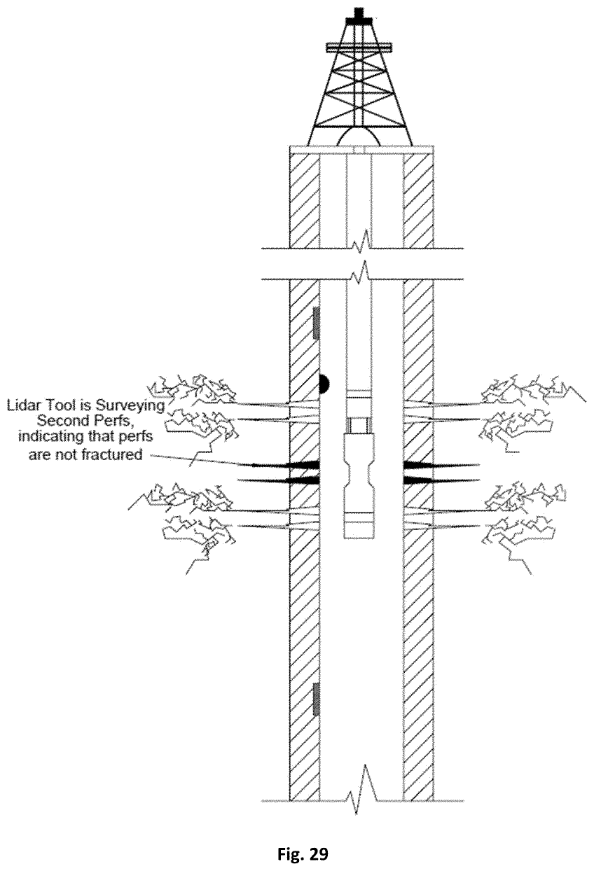

With particular reference to FIGS. 28-30, embodiments of the invention may involve surveying perforations and fractures. One or more perforations may be identified, located, and the physical characteristics such as size, configuration, and orientation, of the perforations may be recorded. In some instances, a perforation may be associated with a corresponding fracture in the formation that was created at the same time as that perforation. As part of the survey, such fractures may be identified, located, and the physical characteristics such as size, configuration, and orientation, of the fractures may be recorded.

In some instances, the perforation explosive charge may cause a perforation in the casing, but not a corresponding fracture in the formation, or in the cement that is interposed between the casing pipe and the formation. Thus, example surveys may identify areas in the formation where a fracture was expected to occur, but did not. The perforation characteristics in such cases may be of particular interest since the lack of a fracture may indicate a problem with the perf gun or perf charge, or an unexpected formation type.

D.6 Further Considerations Concerning Methods and Use Cases

It is noted that the methods and processes disclosed in the Figures referred to in this section D may be performed in the order in which the Figures are presented, although that particular order is not necessarily required. For example, the order in which the perforations are surveyed may be changed from downhole to uphole, to uphole to downhole. Moreover, in some embodiments, part or all of any of the methods may be omitted. For example, a set of perforations may be omitted from the survey. These same considerations apply as well to all of the other disclosed methods and processes, and not only to those disclosed in this section D.

It is further noted that although the wellbore casing is indicated in various Figures as vertically oriented with respect to the surface where the wellhead is located, the scope of the invention is not limited for use with vertically oriented wells and well casings. Rather, embodiments of the invention may be employed in any downhole environment, regardless of whether, for example, the downhole environment includes vertical portions, horizontal portions, both vertical and horizontal portions, and/or, other portions that are neither vertical nor horizontal. These same considerations apply as well to all of the other disclosed methods and processes, and not only to those disclosed in this section D.

In any of the embodiments disclosed elsewhere herein, as well as the example use cases disclosed in this section D, a LiDAR module, or possibly multiple LiDAR modules, may be allowed to remain downhole, at one or more particular locations, for an indefinite period of time. During this time downhole, the components and sensors of the LiDAR module(s) may gather, store, process, and transmit, data concerning downhole conditions on an ongoing basis. In this way, data may be gathered concerning changes in conditions over time without requiring multiple deployments and retrievals of the LiDAR module. This approach may be especially useful when downhole conditions are expected to be dynamic and rapidly changing such that multiple deployments of the LiDAR module may not be adequate to capture all the needed data.

### E. Aspects of an Example LiDAR Module

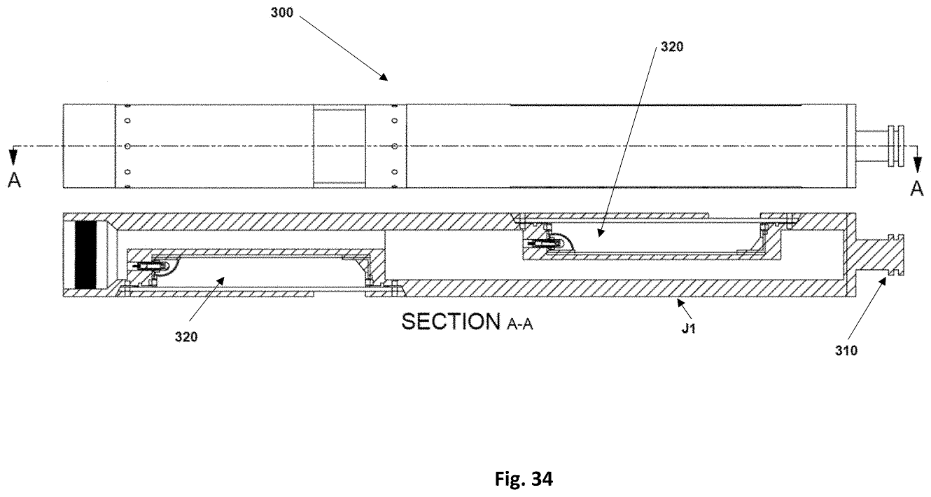

With reference next to FIGS. 33-46, details are provided concerning various aspects of a LiDAR module, one example of which is denoted generally at 300.

E.1 Example LiDAR Module—Overview

As shown in FIG. 33, the LiDAR module 300 may include a shield plate A1-A2. The shield plate A1-A2 may be made of any suitable material(s), examples of which include, but are not limited to, the family of austenitic nickel-chromium-based superalloys sold under the registered mark Inconel® or generally available substitutes, stainless steel, aluminum, steel, titanium, zinc, chromium, nickel, carbon steel, iron, and tungsten. Any of these materials may be treated and or aged to meet external environment operating conditions of corrosion, abrasives, temperature, pressure, physical impacts, and chemicals. Part(s) or all of the shield plate A1-A may be formed by machining, casting, stamping, and/or three dimensional (3D) additive manufacturing techniques that may produce a 3D printed metal part. The shield plate A1-A2 may act as a protection piece between a glass shield, discussed below, and the physical environment in which the LiDAR module 300 is deployed for performing surveying and/or other operations. Such physical environments where the LiDAR module 300 may be deployed for surveying and other operations include, but are not limited to, the interior of metal, and or, polymer/elastomer pipe, such as well casings for example, at the surface, and below the surface, that is, subsurface environments.

With continued reference to FIG. 33, a glass shield B1-B2 is disclosed. The glass shield B1-B2 may be made of any suitable material(s), examples of which include, but are not limited to, conventional laminated glass, insulated ballistic glass, acrylic, polycarbonate, and glass-clad polycarbonate. The glass shield B1-B2 may be formed using various processes, such as molding for example. Among other things, the glass shield B1-B2 may act as a clear vision insulator between a laser, prism, and receiver, discussed below. The glass shield B1-B2 may enable the laser light to pass through the glass shield B1-B2 so as to enable illumination, by the laser, of an object or feature, and the glass shield B1-B2 may likewise enable laser light reflected by the object or feature to the receive by passing through the glass shield B1-B2. In this way, the glass shield B1-B2 may enable examination of various features and objects in operating environments such as subsurface operating environments. Example objects and features that may be examined and mapped by the LiDAR module 300 in operating environments include, but are not limited to, an interior of a pipe where interior pipe features may include deformations, perforations, leaks, cylindricity, collar locations, coupling locations. Other downhole features and objects that may be examined and mapped by the LiDAR module 300 may include, particulates, damage, downhole fish tops, lost BHAs (Bottom Hole Assembly), tools in a pipe, debris, and any other areas of interest. A BHA may comprise, for example, a section of a downhole tool that connects a drill pipe to another component, such as a rock bit for example.

FIG. 33 further discloses a compression gasket seal C1-C2, which may be made of a polymer or elastomer, for example. Molding or additive manufacturing techniques, such as 3D printing, may be used to form a compression gasket seal. The gasket seal C1-C2 may provide various useful functionalities such as, for example, acting as a cushioning, shock absorbing, and sealing device between the glass shield B1-B2 and the body of the LiDAR module 300.

As indicated in FIG. 33, the example LiDAR module 300 may further comprise a laser and receiver shield D1-D2. Some embodiments of the laser and receiver shield D1-D2 may be made of material(s) including, but not limited to, conventional laminated glass, insulated ballistic glass, acrylic, polycarbonate, and/or, glass-clad polycarbonate. The laser and receiver shield D1-D2 may be made using various processes, such as molding, for example. The laser and receiver shield D1-D2 may act as a secondary backup clear vision insulator and mounting piece for the laser and receiver.

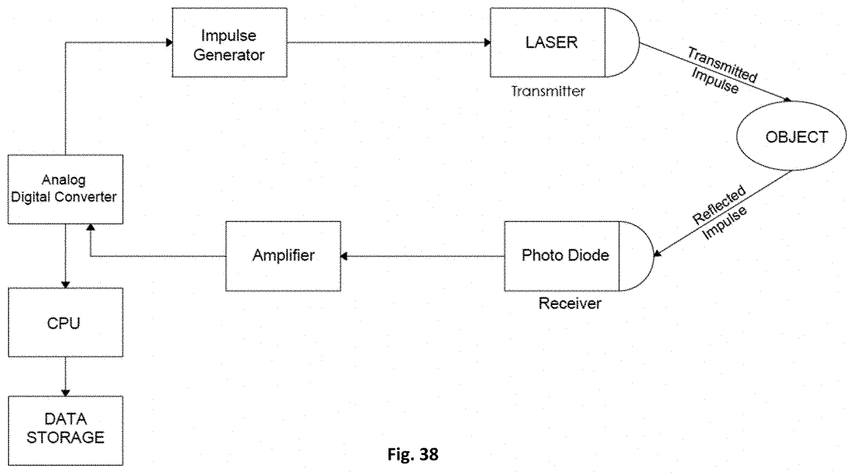

As noted earlier, the example LiDAR module 300 may include a laser and receiver, denoted at E1-E2 in FIG. 33. For example, the laser and receiver E1-E2 may comprise a bathymetric device or sonar device that uses sound waves to locate, identify, and map underwater features, and or LiDAR, laser and receiver. The laser and receiver E1-E2 may contain a light source such as a laser, and a receiver or detector, such as a photodiode for example, that is operable to receive an optical signal, such as reflected laser light, and convert the received optical signal to an electrical signal. In some embodiments, the light source may be an array that comprises, for example, multiple lasers. Similarly, the receiver or detector may be an array that comprises, for example, multiple photodiodes. Goggles may be implemented into the system to ensure field of view precision. A respective goggle may be provided for each of the light source/laser for the receiver. In operation, light from the laser or other light source may pass through a prism (see FIG. 37) and be deflected by the prism to the feature or object that is being evaluated. At least some of the transmitted light may then be reflected by the feature or object back through the prism to the receiver. Examples of downhole objects and features that may be examined and mapped through use of the laser and receiver E1-E2 are disclosed elsewhere herein.

In some alternative embodiments, one or more mirrors may be used instead of, or in addition to, a prism. Similar to a prism, the mirror may direct an optical signal from a laser to a downhole feature, and the mirror may then receive light reflected by the downhole feature and direct the reflected light back to a detector.

FIG. 33, as well as FIG. 37, disclose an example prism F1-F2 that may be an element of some embodiments of the LiDAR module 300. The prism F1-F2 may be made of any suitable material(s), examples of which include, but are not limited to, glass, acrylic, and fluorite. As light enters the prism F1-F2, the prism bends, or refracts, the light. The extent to which light is refracted by the prism is a function of the wavelength of the light. Thus, a prism splits the incoming light entering the input side of the prism according to wavelength so as to generate a spectrum of light emanating from the output side of the prism. For coherent light of a single wavelength, such as laser light for example, the prism refracts the incoming light to produce an output beam having a wide angle of incidence with high precision. The reflected portion of the laser beam then returns to the prism F1-F2 and back to the receiver where the survey data is then sent to a CPU/data acquisition system, examples of which are disclosed elsewhere herein. The prism F1-F2 may also reduce the scatter area of the output beam and allow for more accurate measurements and surveys.

As further disclosed in FIG. 33, the LiDAR module 300 may further comprise a laser and receiver mount G1-G2 which may be made of any suitable material(s), examples of which include Inconel, stainless steel, aluminum, steel, titanium, zinc, chromium, nickel, carbon steel, iron, and tungsten. An elastomer/polymer strip may also be provided between the assembly mount, discussed below, and the laser and receiver mount. This thin strip may act as a cushion and or shock absorber, and may also serve to prevent the ingress of foreign matter. The laser and receiver mount G1-G2 may be mounted to the assembly mount.

FIG. 33 further indicates that the prism F1-F2 may be mounted to a prism mount H1-H2. The prism mount H1-H2 which may be made of any suitable material(s), examples of which include Inconel, stainless steel, aluminum, steel, titanium, zinc, chromium, nickel, carbon steel, iron, and tungsten. As in the case of the laser and receiver mount G1-G2, an elastomer/polymer strip may be provided between the assembly mount and the prism mount. This thin strip may act as a cushion and or shock absorber, and may also serve to prevent the ingress of foreign matter. The prism mount may be mounted to the assembly mount.

With continued reference to FIG. 33, the example LiDAR module 300 may include an assembly mount I1-I2 that may be made of any suitable material(s), examples of which include the metals sold under the Inconel® mark, stainless steel, aluminum, steel, titanium, zinc, chromium, nickel, carbon steel, iron, and tungsten. In general, the assembly mount I1-I2 may act as a rigid connection to the assembly body, discussed below.

In more detail, example embodiments may include an assembly body J1 that may be made of any suitable materials, examples of which include the metals sold under the Inconel® mark, stainless steel, aluminum, steel, titanium, zinc, chromium, nickel, carbon steel, iron, and tungsten. These materials may, or may not, be treated and or aged to meet external environment operating conditions of corrosion, abrasives, temperature, pressure, chemicals, and other environment conditions and factors disclosed herein. In some embodiments, the assembly body J1 may be made up of machined material, fabricated, and then fit up by welding and/or fastened connections using suitable fasteners. The assembly body J1 may alternatively be manufactured using an additive manufacturing process such as 3D printing. The assembly body J1 may serve to house electrical wiring and other components included in the LiDAR module 300. Where it is used, or expected to be, in high pressure environments that may include high pressure gas(es) and/or high pressure fluid(s), the assembly body J1 may include a pressure equalization system that may operate to maintain the internal pressure of the assembly body J1 at, or within an acceptable range of, the pressure of the external environment. One example pressure equalization system may employ a hydraulic accumulator and reservoir.

E.2 LiDAR Module Cross Section

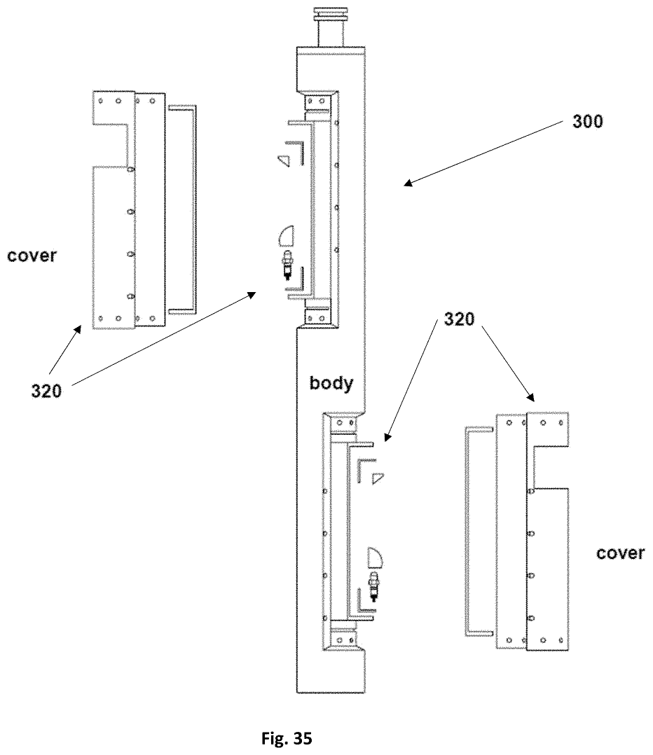

With reference next to FIG. 34, details are provided concerning a cross section of the example LiDAR module 300 and, particularly, a cross-section of the assembly body J1 shown in FIG. 33. The assembly body J1 may be made using various production and manufacturing processes. For example, the assembly body J1 may be machined out of solid bar material. The solid bar material can be machined to include a shape and dimensions that generally conform to the shape and dimensions of a cylindrical pipe. The open-end coupling is machined and threaded to allow to mate to standard sub connections or to accommodate any BHA (Bottom Hole Assembly).

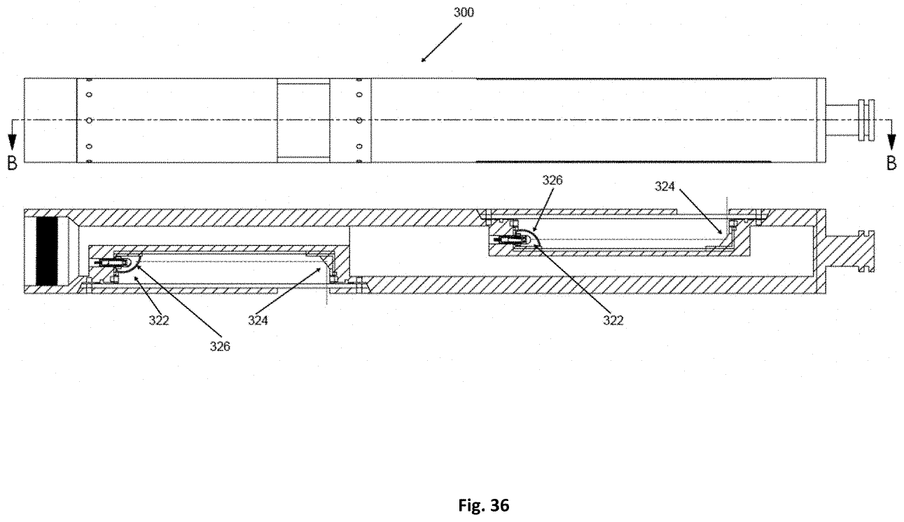

A closed end pressure coupling 310 of the assembly body J1 may be machined with solid bar, or TIG or MIG welded to the machined cylinder, or LiDAR module 300. There may be a machined pathway (not shown in FIG. 34) through the center of the closed end pressure coupling 310 to allow for electronics and instrumentation to travel through. As shown in FIGS. 34 and 35 for example, the LiDAR to prism sections 320 of the LiDAR module 300 may be oriented at 180 degrees, relative to each other, in each direction. This arrangement of the LiDAR to prism sections 320 may allow for a complete scan of 360 degrees around a circumference of the LiDAR module 300.

The LiDAR to prism sections 320 may be conventionally machined, or EDM (Electrical Discharge Machined), into the cylinder to allow for the 180 degree cut. After this machining, the next process may be to fabricate and weld up the sections for installing the laser and prism with all necessary installation material and parts. In some instances, the LiDAR module 300, or portions of it, may be 3D Printed. The 3D print approach may involve creation of two parts that may be printed separately from each other and then welded, or fused, together to make a complete assembly body. Advantageously, 3D printing may avoid the welding and fit up processes and may possibly avoid the need for machining and EDM work as well.

Finally, FIG. 35 discloses an exploded view of an example LiDAR module. As well, FIG. 35 discloses an example assembly sequence for at least a portion of a LiDAR module.

E.3 LiDAR Module Laser/Prism Configuration

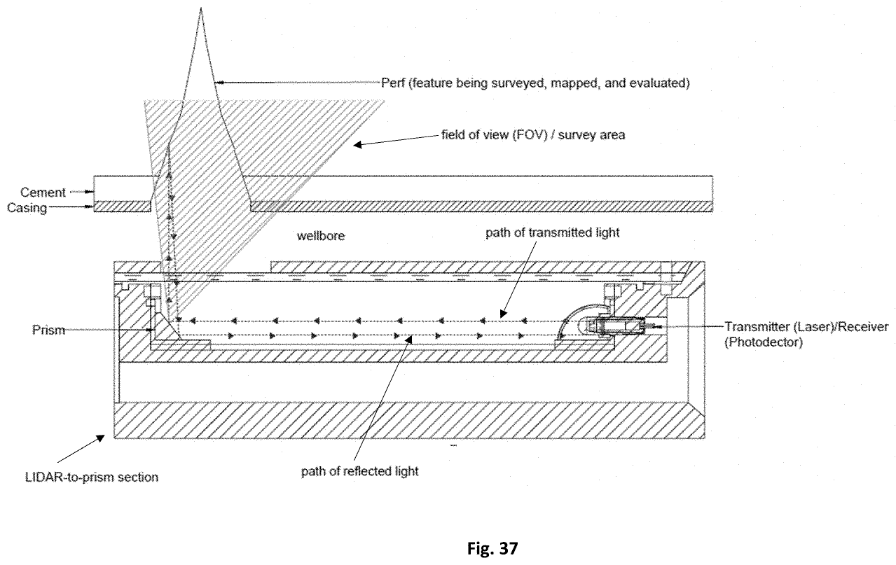

With attention next to FIG. 36, an example laser 322/prism 324 configuration for some LiDAR modules is disclosed. Any number, such as 1, 2, 3, or more, of laser/prism configurations may be employed in a LiDAR module. Corresponding goggles 326, discussed above, may also be provided. It is noted that while reference herein is made to a ‘laser’ or other light source or light transmitter, embodiments of the invention may, in general, employ an optoelectronic transceiver that is operable to both transmit and receive optical signals. The transmitter portion of an optoelectronic transceiver may comprise one or more lasers or other optical transmitters that are operable to convert an electrical signal to an optical signal. In some embodiments, a prism may be an element of the optoelectronic transceiver while, in other embodiments, the prism may be separate from the optoelectronic transceiver. The receiver, or detector, portion of the optoelectronic transceiver may comprise one or more optical receivers, such as photodiodes for example, that are operable to convert an optical signal to an electrical signal. The transmitter and receiver may, or may not, be housed in a single housing.

The use of a pair of laser 322/prism 324 configuration may enable performance of a 180-degree scan by the LiDAR module 300. Such a configuration may allow embodiments of the invention to scan the entire circumference of the interior of the tubing, pipe, casing, work string, or production string wall.

In some embodiments, a laser/prism configuration may be modified to enable a direct laser scan at the front of, rather than the sides of, the assembly looking forward, with or without a prism. This type of configuration may enable the LiDAR module to see directly in front of a BHA, tool, or device that is downhole or inside of the tubing, pipe, casing, work string, or production string. This configuration may also be suited to survey the ID (Inside Diameter) of a pipe, casing, tube, or hole, as well as objects in front of the LiDAR module, and this configuration may also be used as a visualization tool for autonomous capabilities for navigation. In some embodiments, an AI (Artificial Intelligence) algorithm may be employed to train the LiDAR module for autonomous navigation, and/or an AI algorithm may be used to enable autonomous navigation by the LiDAR module in real time so that no training process is needed.

As well, embodiments may employ a laser/prism configuration that have been modified to allow for a direct laser scan behind, or in the back of, the LiDAR module looking backwards, with or without a prism. This type of configuration may enable the LiDAR module and an operator to see directly behind a BHA, tool, or device that is downhole or inside of the tubing, pipe, casing, work string, or production string. This would also be suited to survey the ID, objects behind, and be used as a visualization tool for autonomous capabilities for navigation. The ability of some embodiments of the LiDAR module to see behind, and/or in front of, the LiDAR module may enable the LiDAR module to see behind and in front of BHA, tool, or device surveying capabilities would allow for one laser, or multiple lasers, to scan and survey over 360 degrees so that, for example, the LiDAR module could survey the entire circumference of the inside of a pipe, tube, casing, or other downhole structure or feature. Any of the embodiments disclosed herein may employ a video camera so that an operator of the LiDAR module can see the conditions in the downhole environment where the LiDAR module is deployed.

The disclosed configurations of a laser/prism, and associated receiver or detector, may be useful in a variety of applications and circumstances. For example, such configurations may be employed in downhole fishing processes to retrieve downhole equipment. Another example application is autonomous navigation inside of tubing, pipe, casing, work string, or production string. A further application is surveying production tubing for inspection of tubing wall integrity/thickness and deformities, performed at the surface, downhole, and inside the wellbore. As a final example application, such configurations of a laser/prism/receiver may be employed in surveying, at the surface for example, coiled tubing inside diameter.

E.4 Field of View (FOV)

With attention next to FIG. 37, details are provided concerning a FOV (Field of View) that may be obtained with some example embodiments. As used herein, the FOV refers to an area covered by a survey. The area of survey disclosed in FIG. 37 is an example of a 180-degree scan from laser to prism, that scans a perforation that was created by a perf gun. In this illustrative example, the survey may measure the penetration depth of the perforation, the diameter of the perforation, the orientation of the perforation, the depth in the wellbore where the perforation is located, and the shape of the perforation.

E.5 Operational Aspects of Some Example LiDAR Modules

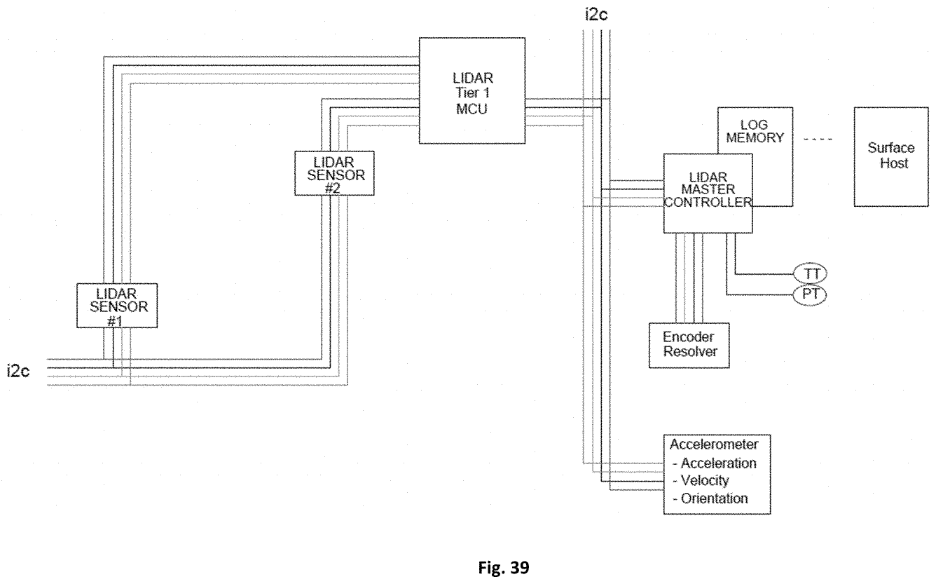

With attention next to FIG. 38, details are provided concerning various example operations that may be performed by and/or at the direction of, a LiDAR module. In some embodiments, all of the components disclosed in FIG. 38 may be implemented in a single LiDAR module, although that is not necessarily required.

As shown, the LiDAR module may include an impulse generator. The impulse generator may operate to generates voltages needed to support the generation of light by the laser(s) and/or other light sources. In some embodiments, the generated voltages may vary based on pressure and temperature in the environment where the LiDAR module is operating, or is expected to operate.

Various types of light sources may be used in example embodiments. Such light sources may include lasers, and/or a topobathymetric LiDAR that enables surveying operations to be performed in a fluid, and which may operate to measure, locate, and map, bathymetric points of interest. In other embodiments, a green laser may be used to scan objects and features in a downhole operating environment.

With continued reference to FIG. 38, it is noted that as used herein, an ‘object,’ such as disclosed in FIG. 38, is intended to be broadly construed. Thus, example objects that may be located, surveyed, mapped, and measured, may include, but are not limited to, deformation, downhole fish, perforations, BHAs, tools, devices, tubing collars, casing collars, pipe collars, dropped objects/lost objects in hole, leaks, holes, and or all areas, objects, and destinations of interest inside of tubing, pipe, casing, work string, or production string downhole in the wellbore and on the surface.

As shown in FIG. 38, light reflected by the object may be received by a detector such as a photodiode. The reflected light returns to the photodiode after the object is scanned, or in an alternative configuration, the reflected light returns first to the prism, and then passes through the prism before being received at the photodiode. If no prism is used, the reflected light may travel directly from the object to the receiver/photodiode. As noted earlier, a detector such as a photodiode may operate to convert an optical signal to an electrical signal.

FIG. 38 further discloses that an example LiDAR module may include an amplifier. In some embodiments, the amplifier may comprise a low-noise transimpedance amplifier (TIA), although that is not necessarily required. Among other things, the amplifier may operate to increases the amplitude of the electrical signals sent by the photodiode. Based on use case, method, or operation of use, for example, the amplifier may be adjusted to suit multiple current ranges, for resolution, accuracy and precision. In some embodiments, the amplifier may operate in a photovoltaic, or photoconductive, mode.

The example LiDAR module may, as indicated in FIG. 38, also comprise an analog-to-digital converter (ADC). The ADC may operate to convert analog signals, received from the amplifier, to digital form. The data gathered by the LiDAR module may be intensified once converted to digital form from analog signals.

With continued reference to FIG. 38, a CPU or computer may be provided that, among other things, operates to process the digital data signal output by the ADC. In at least some embodiments, data processed, and/or generated by, the CPU may comprise uncompressed data. The CPU may process data into a point cloud and/or into other suitable forms and formats. In some embodiments, the CPU may be programmed to compress data and eliminate noise, or to keep the noise in an uncompressed form.

Embodiments of the invention may also comprise memory, such as cache memory for example, and may also comprise storage to hold data. The memory may or may not be persistent non-volatile memory. The data storage may comprise large capacity storage that stores, possibly persistently, all uncompressed data and compressed data. In some instances, compressed data and/or uncompressed data in the data storage may be copied, or transferred, from a downhole location to a surface location, such as by a wifi (wireless) connection, or through a hard electric wireline.

E.6 Electrical Power and Control Aspects of Some Example LiDAR Modules

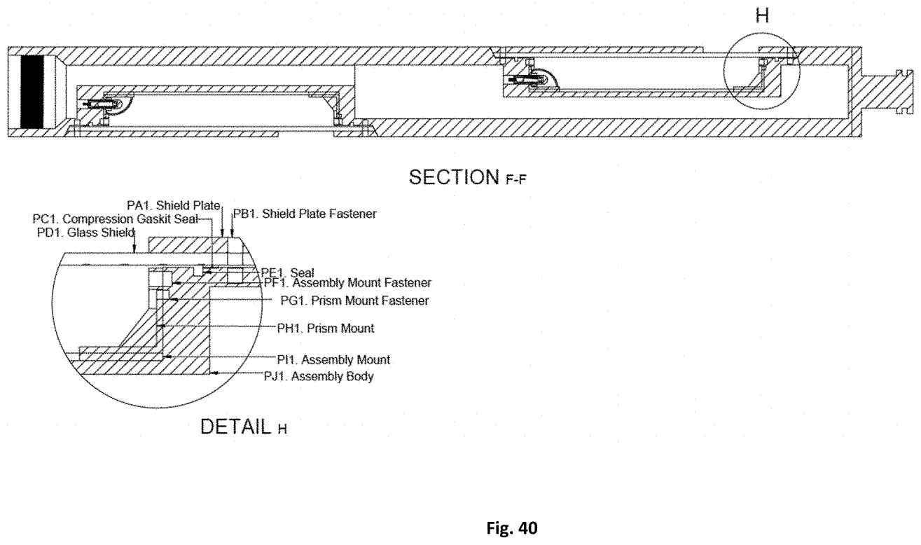

With reference now to FIG. 39, an electric flow diagram is disclosed that provides information concerning power and control aspects of some example embodiments. In general, the system may comprise, and run on, and I2C or CANBUS (Controller Area Network BUS). In general, I2C refers to a serial communication bus that allows all sensors and controllers to communicate with each other. A LiDAR sensor 1 may be provided that is set at 180 degrees for surveying a downhole environment. A LiDAR sensor 2 may also be provided that is set at opposite 180 degrees for surveying. The LiDAR censer 1 and LiDAR sensor 2, in different configurations, may be utilized to scan forward and backward, that is, of the LiDAR module, and may be able to scan multiple different objects and configurations, while still generally conforming to the operational aspects of the electric flow diagram of FIG. 39. Thus, the electric flow diagram, and corresponding LiDAR module, may be configured to allow for multiple LiDAR sensors, or only 1 LiDAR sensor.

A MCU (Master Control Unit) may be provided that operates to control the LiDAR sensors. An encoder and resolver may be used to determine a distance traveled by the LiDAR module, and the speed and position of the LiDAR module. An accelerometer may be provided that may be used to identify the occurrence of various events, such as by sensing, recording, and transmitting, the acceleration and velocity of the LiDAR module as it moves. The accelerometer, or another accelerometer, may also sense, record, and transmit, an orientation of the LiDAR module inside of tubing, pipe, casing, work string, or production string downhole in the wellbore, and on the surface.

E.7 Further Details of Some Example LiDAR Modules

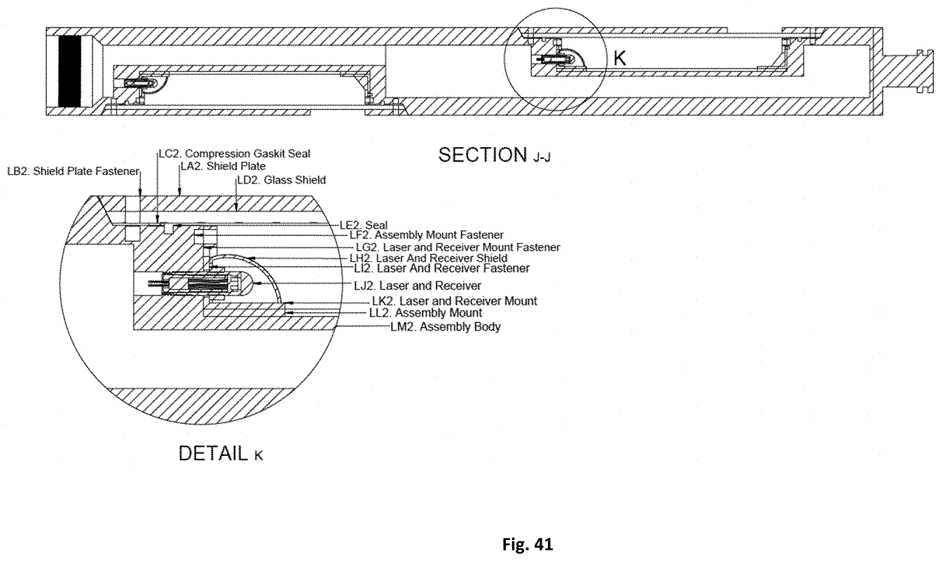

FIGS. 40-46 disclose further details concerning various features and aspects of components disclosed in FIGS. 1-39 discussed above.

### F. Example Computing Devices and Associated Media

The embodiments disclosed herein may include the use of a special purpose or general-purpose computer, as shown in the example of FIG. 47, including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), NVM (Non Volatile Memory), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

With reference briefly now to FIG. 47, any one or more of the entities disclosed, or implied, by FIGS. 1-46 and/or elsewhere herein, may take the form of, or include, or be implemented on, or hosted by, a physical computing device, one example of which is denoted at 400. Part, or all, of the physical computing device 400 may comprise an element of a TLT.

In the example of FIG. 47, the physical computing device 400 includes a memory 402 which may include one, some, or all, of random access memory (RAM) 402, non-volatile memory (NVM) 404, such as non-volatile random access memory (NVRAM), read-only memory (ROM), and persistent memory, one or more hardware processors 406, non-transitory storage media 408, UI device/port 410, and data storage 412. One or more of the memory components 402 of the physical computing device 400 may take the form of solid state device (SSD) storage. As well, one or more applications may be provided that comprise instructions executable by one or more hardware processors to perform any of the operations, or portions thereof, disclosed herein. Such executable instructions may take various forms including, for example, instructions executable to perform any method, process, or portion of these, disclosed herein.

### G. Further Aspects and Example Embodiments

Following are some further example aspects and embodiments of the invention. These are presented only by way of example and are not intended to limit the scope of the invention in any way.

G.1 Example Sensors

Embodiments of a TLT, and embodiments of a downhole string that includes a TLT, may include additional or alternative sensors to those disclosed elsewhere herein. Example sensors include, but are not limited to, any sensor configured to detect and report on any aspect of an operating environment of the TLT. Thus, such sensors may be operable to detect various physical, electrical, and/or other parameters of an operating environment including, but not limited to, the presence of, and/or changes in, position of the TLT, gases, fluids, sound, temperature, pressure, humidity, and particulate concentration. Other sensors and devices that may be employed in embodiments of a TLT include, but are not limited to, lights, radio transmitters, radio receivers, GPS receivers, video cameras, still cameras, microphones, optical transmitters, optical receivers/detectors, hydrophones, rotary optical encoders, ultrasonic transmitters/receivers, and/or, magnetic and electromagnetic field detectors. Any sensor or device may be configured to transmit information concerning measurements made by that sensor or device. In some embodiments, the TLT may be equipped to acoustically communicate, such as by sonar or similar techniques, with other tools, systems, and devices, downhole in the wellbore. These communications may be monitored and/or controlled from the surface, in some embodiments.

G.2 Production Tube Surveying

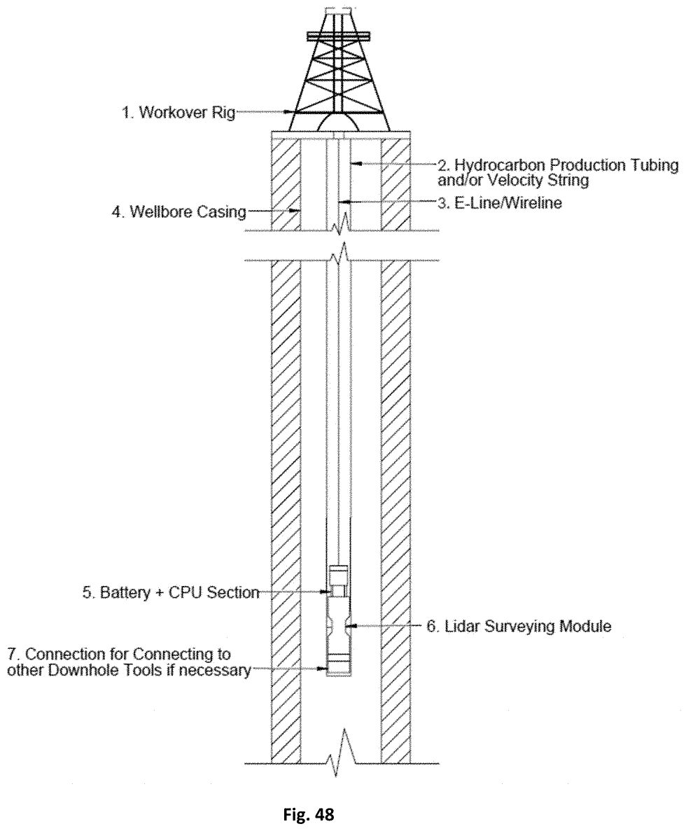

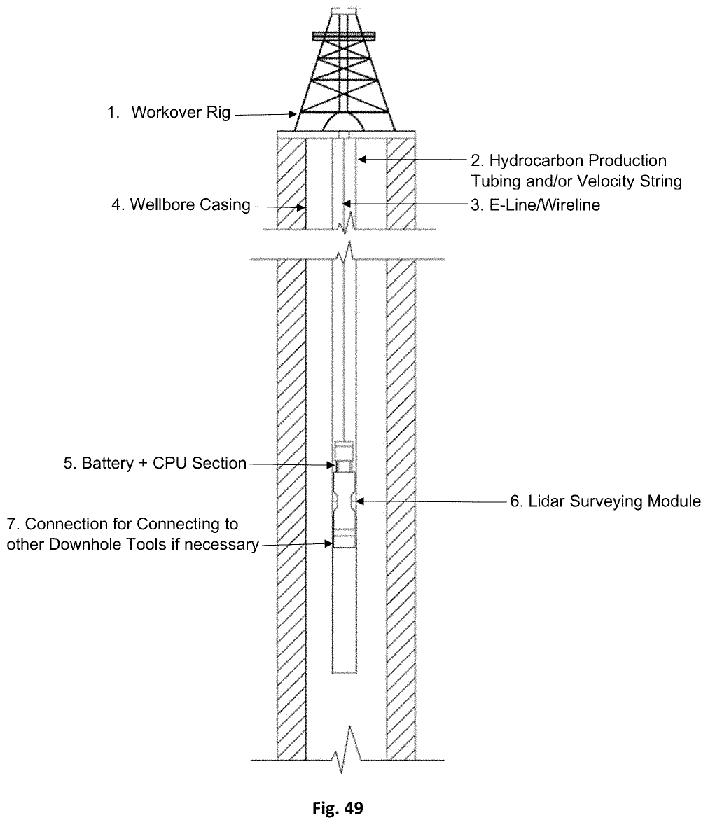

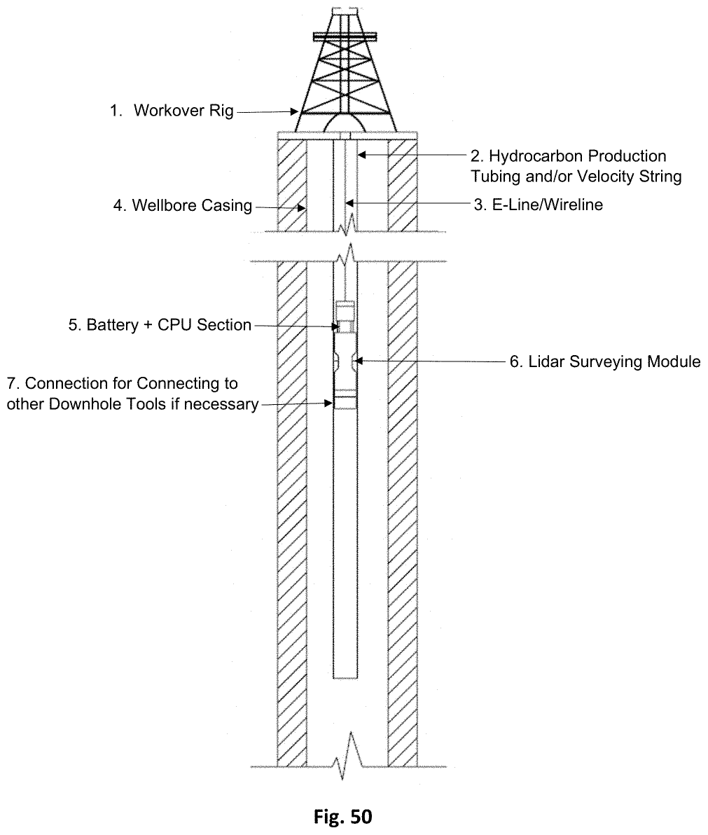

With attention now to FIGS. 48-50, details are provided concerning a further example application according to some embodiments of the invention. In general, the example embodiment of FIGS. 48-50 is concerned with using a TLT and LiDAR module to survey production tubing, where such surveying may include, but is not limited to, obtaining integrity data concerning the production tubing, that is, data concerning the structural integrity of the production tubing and/or associated production tubing components. Processes that may be employed in one example method are disclosed in FIG. 48. In FIG. 48, the LiDAR module has been lowered to the bottom of the production tubing. FIGS. 49 and 50 indicate some example intermediate positions of the LiDAR module as it is retrieved toward the surface during a surveying operation. It is noted that surveying may be performed as the LiDAR module is deployed downhole and/or as the LiDAR module is being retrieved from a downhole position toward the surface.

G.3 Surface Inspection Services

Some further example embodiments are directed to inspection services which may be performed by a TLT and LiDAR module at the surface. Such inspection services may be performed, for example, on pipe, casing, BHA (Bottom Hole Assembly), tubing, and other components, before those various components are deployed downhole and/or after the components are retrieved from a downhole location to the surface. One example embodiment of an inspection service may proceed as described below, although modifications to the example process will be apparent to those of skill in the art.

Example inspection service methods may be performed regarding a variety of components such as, but not limited to, casings, work string (tubing), production string (tubing), and drill pipe. These components may be located at a well site, or at a location off of the well site.

In terms of the timing of the performance of an inspection service, a component may be inspected at any time. For example, a component may be inspected prior to placement in a downhole location such as a well or hole, while the component resides at the downhole location, and/or, after the component is removed from the downhole location and laid down on the surface. In some cases, casing may only be surveyed before it is placed in the wellbore, since casing is typically not removed from the well once positioned downhole.

Initially, the LiDAR module, which may be incorporated as an element of a TLT for example, may be placed inside a component such as pipe, activated, and then self-propel itself along part or all of the length of the pipe and scan the entire ID of the pipe and the ID of the collar/box. Data gathered during the scan, or survey, may include, for example, data concerning features such as cracks, fractures, and deformations, of the surveyed component. A scan may additionally, or alternatively, collect data such as measurements of a true or actual, as opposed to nominal, inside diameter (ID) of the component, and a true thread survey of thread depth measurements and thread peak measurements of a threaded portion of the component being surveyed. In some embodiments, a survey may comprise, or consist of, removing the LiDAR module from the component, such as a pipe for example, and using the LiDAR module to scan the threads on the OD connection at the end of the pipe. Thus, example surveys may involve gathering data concerning both interior features of a component, as well as exterior features of a component.

### H. Further Example Embodiments

Embodiment 1. An apparatus, comprising: a Time of Flight (TOF)/LiDAR tool including one or more optical transmitters and optical receivers that are operable to cooperate with each other to obtain data concerning a downhole feature when the apparatus is deployed in a downhole environment; a first device operable to determine a position, speed, and/or orientation, of the Time of Flight (TOF)/LiDAR tool, when the Time of Flight (TOF)/LiDAR tool is deployed in the downhole environment; a second device configured to store the data locally and/or transmit the data to a location on a surface; a power source connected to the Time of Flight (TOF)/LiDAR tool, the first device, and the second device; and a housing within which the Time of Flight (TOF)/LiDAR tool, first device, second device, and power source are disposed, and the housing includes a connector configured to interface with a piece of downhole equipment.

Embodiment 2. The apparatus as recited in embodiment 1, further comprising a LiDAR module that includes the one or more optical transmitters.

Embodiment 3. The apparatus as recited in embodiment 2, wherein the LiDAR module is operable to detect, locate, and map, features in front of, and behind, the apparatus, when the apparatus is in a downhole environment.

Embodiment 4. The apparatus as recited in embodiment 2, wherein the LiDAR module is operable to detect, locate, and map, features located on all sides of the apparatus, when the apparatus is in a downhole environment.

Embodiment 5. The apparatus as recited in any of embodiments 1-4, wherein the features comprise any one or more of: perforation location; perforation orientation; perforation diameter; penetration depth of a perforation; a casing wall deformity; a collar location; a deviation in a case wall; a casing wall leak; and, an inside diameter of a casing.

Embodiment 6. The apparatus as recited in any of embodiments 1-5, wherein the apparatus further comprises a wireline connection, and the connector of the housing is configured to interface with a perf gun.

Embodiment 7. The apparatus as recited in any of embodiments 1-6, wherein the optical transmitter comprises a laser.

Embodiment 8. A method, comprising: deploying a Time of Flight (TOF)/LiDAR tool including a LiDAR module to a downhole location; and using the LiDAR module to perform operations comprising: detecting a downhole feature; gathering data concerning the downhole feature; and transmitting the data.

Embodiment 9. The method as recited in embodiment 8, wherein the operations further comprise storing the data, and processing the data.

Embodiment 10. The method as recited in any of embodiments 8-9, wherein the operations further comprise mapping, or facilitating mapping of, the downhole feature using the data.

Embodiment 11. The method as recited in any of embodiments 8-10, wherein the operations further comprise perforating a well casing, and the downhole feature comprises a perforation in the well casing.

Embodiment 12. The method as recited in embodiment 11, wherein the perforating is performed as the Time of Flight (TOF)/LiDAR tool is being lowered down the downhole location.

Embodiment 13. The method as recited in any of embodiments 8-12, wherein the gathering of the data is performed as the Time of Flight (TOF)/LiDAR tool is being retracted from the downhole location.

Embodiment 14. The method as recited in any of embodiments 8-13, wherein the method is performed as part of a frac preparation phase for a well and/or surveillance of a disposal/injection well.

Embodiment 15. A method, comprising: deploying a Time of Flight (TOF)/LiDAR tool including a LiDAR module within a component and/or at an exterior portion of the component, wherein the component is located on the surface rather than in a downhole location; and using the LiDAR module to perform operations comprising: detecting a component feature; gathering data concerning the component feature; and transmitting the data.

Embodiment 16. The method as recited in embodiment 15, wherein the component feature comprises one or more of threads, and thread connections.

Embodiment 17. The method as recited in any of embodiments 15-16, wherein the component comprises a bottom hole assembly.

Embodiment 18. The method as recited in any of embodiments 15-17, wherein the data comprises data about any one or more of: a perforation location; a perforation orientation; a perforation diameter; a penetration depth of a perforation; a casing wall deformity; a collar location; a deviation in a case wall; a casing wall leak; a flow rate through a perforation; a temperature of a perforation; and, an inside diameter of a casing.

Embodiment 19. The method as recited in any of embodiments 15-18, wherein deploying a Time of Flight (TOF)/LiDAR tool comprises pumping the Time of Flight (TOF)/LiDAR tool down to the downhole location.

Embodiment 20. The method as recited in any of embodiments 15-19, wherein the LiDAR module operates to map an entire wellbore that includes the downhole location.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a Time of Flight (TOF)/LiDAR tool including one or more optical transmitters and optical receivers that are operable to cooperate with each other to obtain data concerning a downhole feature when the apparatus is deployed in a downhole environment;
a first device operable to determine a position, speed, and/or orientation, of the Time of Flight (TOF)/LiDAR tool, when the Time of Flight (TOF)/LiDAR tool is deployed in the downhole environment;
a second device configured to store the data locally and/or transmit the data to a location on a surface;
a power source connected to the Time of Flight (TOF)/LiDAR tool, the first device, and the second device; and
a housing within which the Time of Flight (TOF)/LiDAR tool, first device, second device, and power source are disposed, and the housing includes a connector configured to interface with a piece of downhole equipment.

2. The apparatus as recited in claim 1, further comprising a LiDAR module that includes the one or more optical transmitters.

3. The apparatus as recited in claim 2, wherein the LiDAR module is operable to detect, locate, and map, features in front of, and behind, the apparatus, when the apparatus is in a downhole environment.

4. The apparatus as recited in claim 2, wherein the LiDAR module is operable to detect, locate, and map, features located on all sides of the apparatus, when the apparatus is in a downhole environment.

5. The apparatus as recited in claim 1, wherein the features comprise any one or more of: perforation location; perforation orientation; perforation diameter; penetration depth of a perforation; a casing wall deformity; a collar location; a deviation in a case wall; a casing wall leak; and, an inside diameter of a casing.

6. The apparatus as recited in claim 1, wherein the apparatus further comprises a wireline connection, and the connector of the housing is configured to interface with a perf gun.

7. The apparatus as recited in claim 1, wherein the optical transmitter comprises a laser.

8. A method, comprising:
deploying a Time of Flight (TOF)/LiDAR tool including a LiDAR module to a downhole location; and
using the LiDAR module to perform operations comprising:
detecting a downhole feature;
gathering data concerning the downhole feature; and
transmitting the data.

9. The method as recited in claim 8, wherein the operations further comprise storing the data, and processing the data.

10. The method as recited in claim 8, wherein the operations further comprise mapping, or facilitating mapping of, the downhole feature using the data.

11. The method as recited in claim 8, wherein the operations further comprise perforating a well casing, and the downhole feature comprises a perforation in the well casing.

12. The method as recited in claim 11, wherein the perforating is performed as the Time of Flight (TOF)/LiDAR tool is being lowered down the downhole location.

13. The method as recited in claim 8, wherein the gathering of the data is performed as the Time of Flight (TOF)/LiDAR tool is being retracted from the downhole location.

14. The method as recited in claim 8, wherein the method is performed as part of a frac preparation phase for a well and/or surveillance of a disposal/injection well.

15. A method, comprising:
deploying a Time of Flight (TOF)/LiDAR tool including a LiDAR module within a component and/or at an exterior portion of the component, wherein the component is located on the surface rather than in a downhole location; and
using the LiDAR module to perform operations comprising:
detecting a component feature;
gathering data concerning the component feature; and
transmitting the data.

16. The method as recited in claim 15, wherein the component feature comprises one or more of threads, and thread connections.

17. The method as recited in claim 15, wherein the component comprises a bottom hole assembly.

18. The method as recited in claim 15, wherein the data comprises data about any one or more of: a perforation location; a perforation orientation; a perforation diameter; a penetration depth of a perforation; a casing wall deformity; a collar location; a deviation in a case wall; a casing wall leak; a flow rate through a perforation; a temperature of a perforation; and, an inside diameter of a casing.

19. The method as recited in claim 15, wherein deploying a Time of Flight (TOF)/LiDAR tool comprises pumping the Time of Flight (TOF)/LiDAR tool down to the downhole location.

20. The method as recited in claim 15, wherein the LiDAR module operates to map an entire wellbore that includes the downhole location.
